(19) United States
(12) Patent Application Publication
(10) Pub. No.: US 2017/0023709 A1
(43) Pub. Date: Jan. 26, 2017

(54) OPTICAL LENS, BACKLIGHT UNIT INCLUDING OPTICAL LENS, AND DISPLAY DEVICE INCLUDING OPTICAL LENS

(71) Applicant: LG ELECTRONICS INC., Seoul (KR)

(72) Inventors: Uihyung LEE, Seoul (KR); Jongho HAN, Seoul (KR); Juyoung JOUNG, Seoul (KR); Wondo KEE, Seoul (KR)

(21) Appl. No.: 14/962,507

(22) Filed: Dec. 8, 2015

(30) Foreign Application Priority Data
Jul. 24, 2015 (KR) 10-2015-0104833

(51) Int. Cl. G02B 3/02; G02F 1/1335

(52) U.S. Cl. CPC G02B 3/02; G02F 1/133606; G02F 1/133608; G02F 2001/133607

(57) ABSTRACT

An optical lens, a backlight unit including the optical lens, and a display device including the optical lens are disclosed. The optical lens includes a first surface forming an upper part, a second surface positioned opposite the first surface and forming a lower part, and a third surface connecting the first surface and the second surface. At least a portion of the second surface forms a bottom parallel to the first surface. At least a portion of the second surface is inclined from the bottom toward the third surface.

### CROSS REFERENCE TO RELATED APPLICATIONS

This application claims the benefit of Korean Patent Application No. 10-2015-0104833 filed on Jul. 24, 2015, the entire contents of which is incorporated by reference for all purposes as if fully set forth herein.

### BACKGROUND

Field of the Disclosure

The present disclosure relates to an optical lens, a backlight unit including the optical lens, and a display device including the optical lens.

Discussion of the Related Art

With the development of the information society, various demands for display devices have been increasing. Various display devices, such as liquid crystal displays (LCDs), plasma display panels (PDPs), electroluminescent displays (ELDs), and vacuum fluorescent displays (VFDs), have been recently studied and used to meet various demands for the display devices.

Among the display devices, a liquid crystal display panel of the liquid crystal display includes a liquid crystal layer, and a thin film transistor (TFT) substrate and a color filter substrate which are positioned opposite each other with the liquid crystal layer interposed therebetween. The liquid crystal display panel displays an image using light provided by a backlight unit of the liquid crystal display.

### SUMMARY

Accordingly, an object of the present disclosure is to address the above-described and other problems.

Another aspect of the present disclosure is to provide an optical lens for efficiently controlling an optical path.

Another aspect of the present disclosure is to provide a backlight unit for uniformly irradiating light.

Another aspect of the present disclosure is to provide a display device having excellent image quality.

In one aspect, there is an optical lens comprising a first surface at an upper part of the optical lens, a second surface at a lower part of the optical lens, wherein a portion of the second surface is a bottom surface of the optical lens and parallel to a portion of the first surface, and a third surface connecting the first surface and the second surface, wherein an inclined portion of the second surface is at an angle from the bottom toward the third surface.

According to another aspect of the present disclosure, the inclined portion of the second surface may have a cross-sectional shape which is straight from the bottom toward the third surface.

According to another aspect of the present disclosure, the inclined portion of the second surface may have a cross-sectional shape which is curved from the bottom toward the third surface.

According to another aspect of the present disclosure, the inclined portion of the second surface may have a cross-sectional shape which is concave toward an inside of the optical lens.

According to another aspect of the present disclosure, the inclined portion of the second surface may have a cross-sectional shape which is convex toward an outside of the optical lens.

According to another aspect of the present disclosure, the inclined portion of the second surface may have a cross-sectional shape which is concave toward the inside of the optical lens and is convex toward the outside of the optical lens.

According to another aspect of the present disclosure, a height between the bottom surface and a point where the second surface and the third surface meet each other may be equal to or less than ⅓ of a height between the bottom surface and a top of the upper part.

According to another aspect of the present disclosure, the third surface may include a straight portion starting at a point where the first surface and the third surface meet each other and a curved surface starting from an end of the straight portion to the second surface.

According to another aspect of the present disclosure, the third surface is not perpendicular to the bottom surface.

According to another aspect of the present disclosure, the third surface is at an angle equal to or less than 5° with respect to the bottom surface.

According to another aspect of the present disclosure, a central area of the second surface includes a concave portion extending toward the first surface.

According to another aspect of the present disclosure, the concave portion may include a first area obliquely extending from a center point of the concave portion toward an outside of the second surface, a second area extending from the first area substantially parallel with the bottom surface, and a third area extending from the second area to the bottom surface.

According to another aspect of the present disclosure, a portion of the third area may include a curved surface.

According to another aspect of the present disclosure, the first surface may include a concave portion extending toward the second surface.

According to another aspect of the present disclosure, the concave portion extends from a center point of the concave portion where the first surface and the third surface meet each other.

According to another aspect of the present disclosure, the concave portion is angled from a boundary between the first surface and the third surface to a maximum depression position of the concave portion.

In another aspect, there is a backlight unit comprising an optical sheet, a substrate opposite the optical sheet, a light source between the substrate and the optical sheet and on the substrate, and an optical lens covering the light source, the optical lens including a first surface at an upper part of the optical lens, a second surface at a lower part of the optical lens, wherein a portion of the second surface is a bottom surface of the optical lens, and a third surface connecting the first surface and the second surface, wherein an inclined portion of the second surface is at an angle from the bottom surface toward the third surface.

In yet another aspect, there is a display device comprising a display panel, a backlight unit behind the display panel, a frame behind the backlight unit, and a back cover behind the frame, wherein the backlight unit includes a light source and an optical lens covering the light source, the optical lens including a first surface at an upper part, a second surface at a lower part, a portion of the second surface forming a bottom surface, and a third surface connecting the first surface and the second surface, wherein an inclined portion of the second surface is at an angle from the bottom surface toward the third surface.

According to another aspect of the present disclosure, the backlight unit further may include an optical sheet, a substrate opposite the optical sheet, and a light source between the substrate and the optical sheet and on the substrate.

According to another aspect of the present disclosure, a diameter of the first surface of the optical lens may be different than a diameter of the second surface of the optical lens.

According to at least one aspect of the present disclosure, the present disclosure can provide the optical lens for efficiently controlling an optical path.

According to at least one aspect of the present disclosure, the present disclosure can provide the backlight unit for uniformly irradiating light.

According to at least one aspect of the present disclosure, the present disclosure can provide the display device having excellent image quality.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1 and 2 illustrate a display device according to an example embodiment of the invention;

FIGS. 3, 4A, 4B, 4C, 5, 6A, 6B, and 7 illustrate a configuration of a display device related to an example embodiment of the invention;

FIGS. 8 and 9 illustrate a light source according to an example embodiment of the invention;

FIG. 10 shows a light assembly including a light source shown in FIG. 9;

FIGS. 11A, 11B, 12A, and 12B show a difference between lenses constituting a light assembly;

FIGS. 13, 14A, and 14B show a lens according to an example embodiment of the invention;

FIGS. 15 to 19 show a second concave portion of a lens shown in FIG. 13;

FIGS. 20 to 22 show a third surface of a lens shown in FIG. 13;

FIGS. 23 and 24 show a first area of a lens shown in FIG. 13;

FIG. 25 shows an example of an optical path due to a lens shown in FIG. 13;

FIGS. 26 to 31 show a lens according to another example embodiment of the invention;

FIGS. 32 to 63 show a lens according to yet another example embodiment of the invention; and

FIGS. 64A, 64B, 65A, and 65B show a disposition of a light assembly according to another example embodiment of the invention.

### DETAILED DESCRIPTION OF THE EMBODIMENTS

Reference will now be made in detail embodiments of the invention examples of which are illustrated in the accompanying drawings. Since the present invention may be modified in various ways and may have various forms, specific embodiments are illustrated in the drawings and are described in detail in the present specification. However, it should be understood that the present invention are not limited to specific disclosed embodiments, but include all modifications, equivalents and substitutes included within the spirit and technical scope of the present invention.

The terms ‘first’, ‘second’, etc. may be used to describe various components, but the components are not limited by such terms. The terms are used only for the purpose of distinguishing one component from other components. For example, a first component may be designated as a second component without departing from the scope of the present invention. In the same manner, the second component may be designated as the first component.

The term “and/or” encompasses both combinations of the plurality of related items disclosed and any item from among the plurality of related items disclosed.

When an arbitrary component is described as “being connected to” or “being linked to” another component, this should be understood to mean that still another component(s) may exist between them, although the arbitrary component may be directly connected to, or linked to, the second component. In contrast, when an arbitrary component is described as “being directly connected to” or “being directly linked to” another component, this should be understood to mean that no component exists between them.

The terms used in the present application are used to describe only specific embodiments or examples, and are not intended to limit the present invention. A singular expression can include a plural expression as long as it does not have an apparently different meaning in context.

In the present application, the terms “include” and “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

Unless otherwise specified, all of the terms which are used herein, including the technical or scientific terms, have the same meanings as those that are generally understood by a person having ordinary knowledge in the art to which the present invention pertains. The terms defined in a generally used dictionary must be understood to have meanings identical to those used in the context of a related art, and are not to be construed to have ideal or excessively formal meanings unless they are obviously specified in the present application.

The following example embodiments of the present invention are provided to those skilled in the art in order to describe the present invention more completely. Accordingly, shapes and sizes of elements shown in the drawings may be exaggerated for clarity.

Hereinafter, the embodiments of the invention are described using a liquid crystal display panel as an example of a display panel. Other display panels may be used. For example, a plasma display panel (PDP), a field emission display (FED) panel, and an organic light emitting diode (OLED) display panel may be used.

In what follows, a display panel may include a first long side LS1, a second long side LS2 opposite the first long side LS1, a first short side SS1 adjacent to the first long side LS1 and the second long side LS2, and a second short side SS2 opposite the first short side SS1.

In the embodiment disclosed herein, the first short side SS1 may be referred to as a first side area; the second short side SS2 may be referred to as a second side area opposite the first side area; the first long side LS1 may be referred to as a third side area which is adjacent to the first side area and the second side area and is positioned between the first side area and the second side area; and the second long side LS2 may be referred to as a fourth side area which is adjacent to the first side area and the second side area, is positioned between the first side area and the second side area, and is opposite to the third side area.

The embodiment of the invention describes that lengths of the first and second long sides LS1 and LS2 are longer than lengths of the first and second short sides SS1 and SS2 for the sake of brevity and ease of reading. However, the lengths of the first and second long sides LS1 and LS2 may be almost equal to the lengths of the first and second short sides SS1 and SS2.

In the following description, a first direction DR1 may be a direction parallel to the long sides LS1 and LS2 of the display panel, and a second direction DR2 may be a direction parallel to the short sides SS1 and SS2 of the display panel.

Further, a third direction DR3 may be a direction vertical to the first direction DR1 and/or the second direction DR2.

In the embodiment disclosed herein, the first direction DR1 and the second direction DR2 may be commonly referred to as a horizontal direction.

Further, the third direction DR3 may be referred to as a vertical direction.

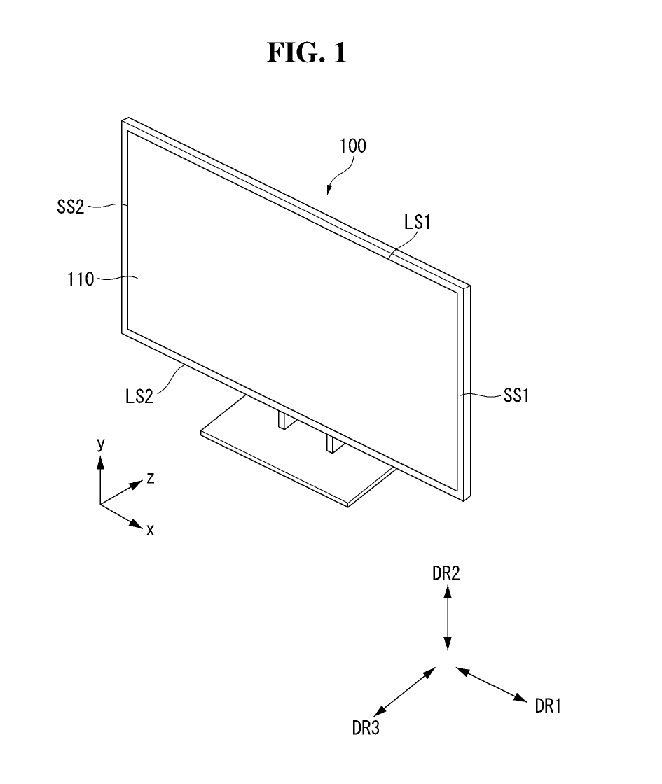

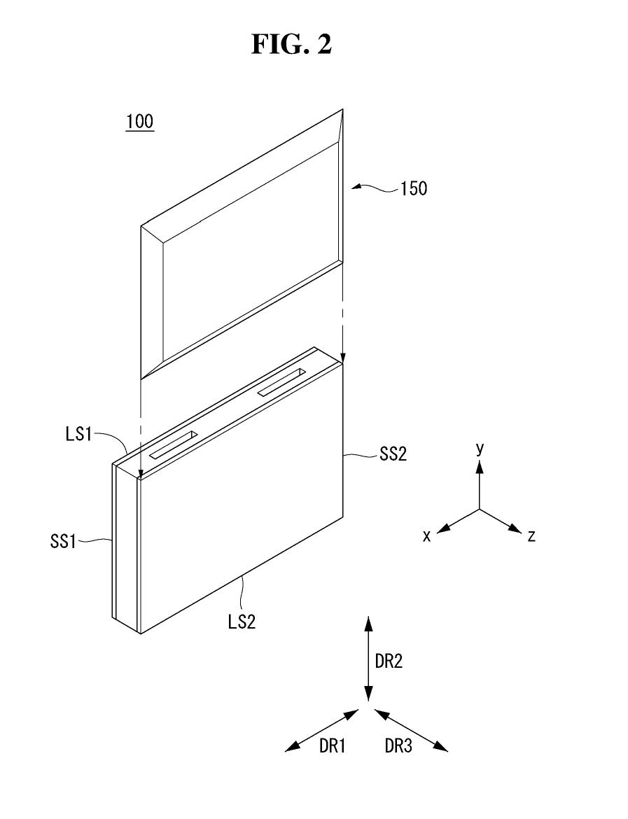

FIGS. 1 and 2 illustrate a display device according to an example embodiment of the invention.

As shown in FIGS. 1 and 2, a display device 100 according to the embodiment of the invention may include a display panel 110 and a back cover 150 positioned in the rear of the display panel 110.

The back cover 150 may be connected to the display panel 110 in a sliding manner in a direction (i.e., the second direction DR2) from the first long side LS1 to the second long side LS2. In other words, the back cover 150 may be inserted into the first short side SS1, the second short side SS2 opposite the first short side SS1, and the first long side LS1 which is adjacent to the first and second short sides SS1 and SS2 and is positioned between the first short side SS1 and the second short side SS2, of the display panel 110 in the sliding manner.

The back cover 150 and/or other components adjacent to the back cover 150 may include a protrusion, a sliding unit, a connection unit, etc., so that the back cover 150 is connected to the display panel 110 in the sliding manner.

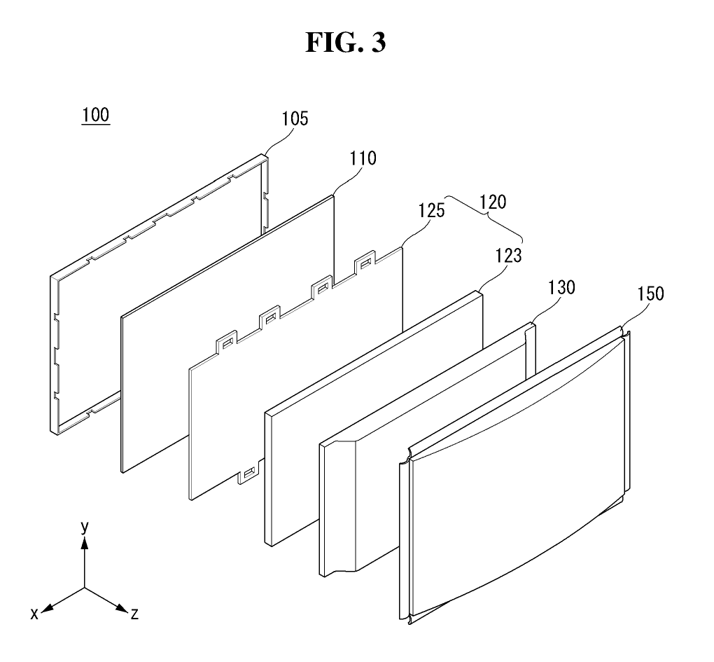

FIGS. 3 to 7 illustrate configuration of a display device related to the embodiment of the invention.

As shown in FIG. 3, the display device 100 according to the embodiment of the invention may include a front cover 105, the display panel 110, a backlight unit 120, a frame 130, and the back cover 150.

The front cover 105 may cover at least a portion of a front surface and a side surface of the display panel 110. The front cover 105 may have a rectangular fame shape, in which a center portion is empty. Because the center portion of the front cover 105 is empty, an image displayed on the display panel 110 may be seen to the outside.

The front cover 105 may include a front cover and a side cover. Namely, the front cover 105 may include the front cover positioned at the front surface of the display panel 110 and the side cover at the side surface of the display panel 110. The front cover and the side cover may be separately configured. One of the front cover and the side cover may be omitted. For example, the front cover may be omitted, and only the side cover may be absent in terms of a beautiful appearance of the display device 100.

The display panel 110 may be positioned in front of the display device 100 and may display an image. The display panel 110 may divide the image into a plurality of pixels and may output the image while controlling color, brightness, and chroma of each pixel. The display panel 110 may include an active area, on which the image is displayed, and an inactive area, on which the image is not displayed. The display panel 110 may include a front substrate and a back substrate which are positioned opposite each other with a liquid crystal layer interposed therebetween.

The front substrate may include a plurality of pixels each including red, green, and blue subpixels. The front substrate may generate an image corresponding to the red, green, or blue color in response to a control signal.

The back substrate may include switching elements. The back substrate may turn on pixel electrodes. For example, the pixel electrode may change a molecule arrangement of the liquid crystal layer in response to a control signal received from the outside. The liquid crystal layer may include a plurality of liquid crystal molecules. The arrangement of the liquid crystal molecules may change depending on a voltage difference between the pixel electrode and a common electrode. The liquid crystal layer may transmit light provided by the backlight unit 120 to the front substrate.

The backlight unit 120 may be positioned at a back surface of the display panel 110. The backlight unit 120 may include a plurality of light sources. The light sources of the backlight unit 120 may be arranged in an edge type or a direct type. In the instance of the edge type backlight unit 120, a light guide plate may be added.

The backlight unit 120 may be coupled to a front surface of the frame 130. For example, the plurality of light sources may be disposed at the front surface of the frame 130. In this instance, the backlight unit 120 may be commonly called the direct type backlight unit 120.

The backlight unit 120 may be driven in an entire driving method or a partial driving method such as a local dimming method and an impulsive driving method. The backlight unit 120 may include an optical sheet 125 and an optical layer 123.

The optical sheet 125 can cause light of the light sources to be uniformly transferred to the display panel 110. The optical sheet 125 may include a plurality of layers. For example, the optical sheet 125 may include at least one prism sheet and/or at least one diffusion sheet.

The optical sheet 125 may further include at least one coupling unit 125d. The coupling unit 125d may be coupled to the front cover 105 and/or the back cover 150. Namely, the coupling unit 125d may be directly coupled to the front cover 105 and/or the back cover 150. Alternatively, the coupling unit 125d may be coupled to a structure formed on the front cover 105 and/or the back cover 150. Namely, the coupling unit 125d may be indirectly coupled to the front cover 105 and/or the back cover 150.

The optical layer 123 may include the light source, etc. The detailed configuration of the optical layer 123 will be described in the corresponding paragraphs.

The frame 130 may support components constituting the display device 100. For example, the frame 130 may be coupled to the backlight unit 120. The frame 130 may be formed of a metal material, for example, an aluminum alloy.

The back cover 150 may be positioned at a back surface of the display device 100. The back cover 150 may protect inner configuration of the display device 100 from the outside. At least a portion of the back cover 150 may be coupled to the frame 130 and/or the front cover 105. The back cover 150 may be an injection production (or injection molded) formed of a resin material.

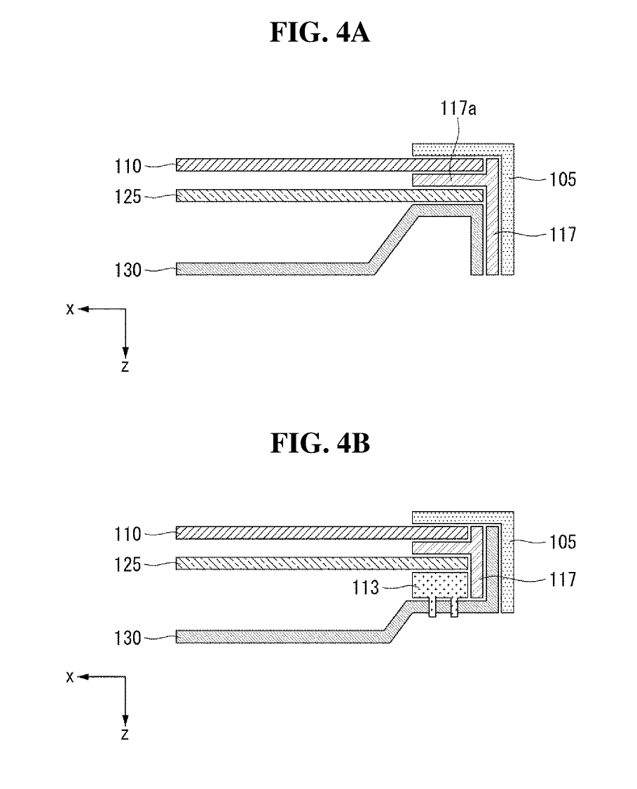

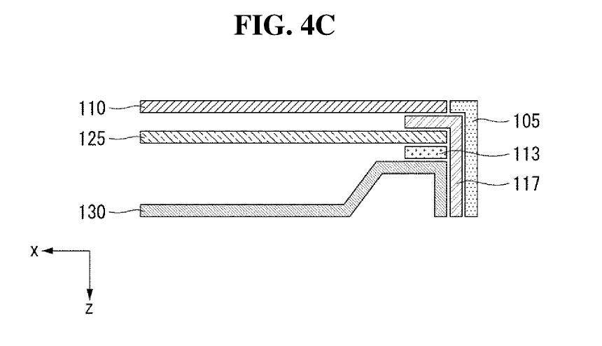

FIG. 4 shows the configuration of the optical sheet 125.

As shown in FIG. 4A, the optical sheet 125 may be positioned on the frame 130. The optical sheet 125 may be coupled to the frame 130 at an edge of the frame 130. The optical sheet 125 may be directly placed at the edge of the frame 130. Namely, the optical sheet 125 may be supported by the frame 130. An upper surface of an edge of the optical sheet 125 may be surrounded by a first guide panel 117. For example, the optical sheet 125 may be positioned between the edge of the frame 130 and a flange 117a of the first guide panel 117.

The display panel 110 may be positioned at a front surface of the optical sheet 125. An edge of the display panel 110 may be coupled to the first guide panel 117. Namely, the display panel 110 may be supported by the first guide panel 117.

An edge area of the front surface of the display panel 110 may be surrounded by the front cover 105. For example, the display panel 110 may be positioned between the first guide panel 117 and the front cover 105.

As shown in FIG. 4B, the display device 100 according to the embodiment of the invention may further include a second guide panel 113. The optical sheet 125 may be coupled to the second guide panel 113. Namely, the second guide panel 113 may have a shape, in which the second guide panel 113 is coupled to the frame 130 and the optical sheet 125 is coupled to the second guide panel 113. The second guide panel 113 may be formed of a material different from the frame 130. The frame 130 may have a shape surrounding the first and second guide panels 117 and 113.

As shown in FIG. 4C, in the display device 100 according to the embodiment of the invention, the front cover 105 may not cover the front surface of the display panel 110. Namely, one end of the front cover 105 may be positioned on the side of the display panel 110.

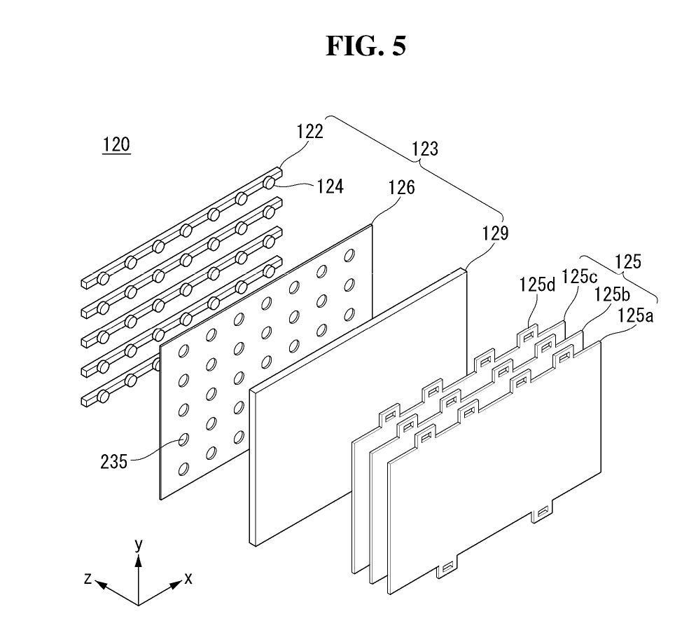

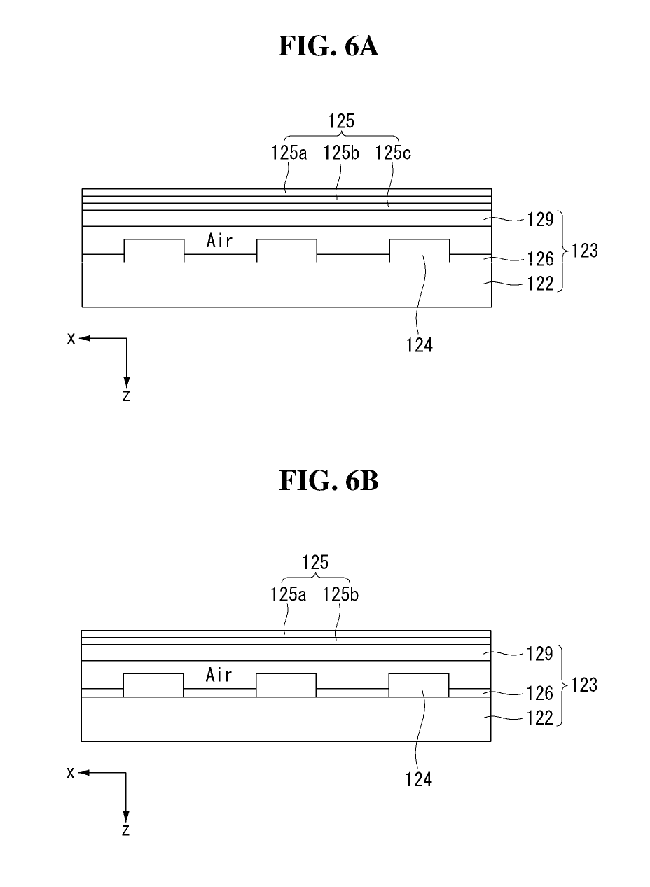

Referring to FIGS. 5 and 6, the backlight unit 120 may include a substrate 122, at least one light assembly 124, the optical layer 123 including a reflecting sheet 126 and a diffusion plate 129, and the optical sheet 125 positioned on a front surface of the optical layer 123.

The substrate 122 may include a plurality of straps, which extend in a first direction and are separated from one another by a predetermined distance in a second direction perpendicular to the first direction.

At least one light assembly 124 may be mounted on the substrate 122. The substrate 122 may have an electrode pattern for connecting an adaptor to the light assembly 124. For example, a carbon nanotube electrode pattern for connecting the adaptor to the light assembly 124 may be formed on the substrate 122.

The substrate 122 may be formed of at least one of polyethylene terephthalate (PET), glass, polycarbonate (PC), and silicon. The substrate 122 may be a printed circuit board (PCB), on which at least one light assembly 124 is mounted.

The light assemblies 124 may be disposed on the substrate 122 at predetermined intervals in the first direction. A diameter of the light assembly 124 may be greater than a width of the substrate 122. Namely, the diameter of the light assembly 124 may be greater than a length of the substrate 122 in the second direction.

The light assembly 124 may be one of a light emitting diode (LED) chip and a LED package having at least one LED chip.

The light assembly 124 may be configured as a colored LED emitting at least one of red, green, and blue light or a white LED. The colored LED may include at least one of a red LED, a green LED, and a blue LED.

The light source included in the light assembly 124 may be a COB (Chip-On-Board) type. The COB light source may have a configuration, in which the LED chip as the light source is directly coupled to the substrate 122. Thus, the process may be simplified. Further, a resistance may be reduced, and a loss of energy resulting from heat may be reduced. Namely, power efficiency of the light assembly 124 may increase. The COB light source can provide the brighter lighting and may be implemented to be thinner and lighter than a related art.

The reflecting sheet 126 may be positioned at the front surface of the substrate 122. The reflecting sheet 126 may be positioned in an area excluding a formation area of the light assemblies 124 of the substrates 122. Namely, the reflecting sheet 126 may have a plurality of holes 235.

The reflecting sheet 126 may reflect light emitted from the light assembly 124 to a front surface of the reflecting sheet 126. Further, the reflecting sheet 126 may again reflect light reflected from the diffusion plate 129.

The reflecting sheet 126 may include at least one of metal and metal oxide which are a reflection material. The reflecting sheet 126 may include metal and/or metal oxide having a high reflectance, for example, aluminum (Al), silver (Ag), gold (Au), and titanium dioxide (TiO2).

The reflecting sheet 126 may be formed by depositing and/or coating the metal or the metal oxide on the substrate 122. An ink including the metal material may be printed on the reflecting sheet 126. On the reflecting sheet 126, a deposition layer may be formed using a heat deposition method, an evaporation method, or a vacuum deposition method such as a sputtering method. On the reflecting sheet 126, a coating layer and/or a printing layer may be formed using a printing method, a gravure coating method or a silk screen method.

An air gap may be positioned between the reflecting sheet 126 and the diffusion plate 129. The air gap may serve as a buffer capable of widely diffusing light emitted from the light assembly 124.

A resin may be deposited on the light assembly 124 and/or the reflecting sheet 126. The resin may function to diffuse light emitted from the light assembly 124.

The diffusion plate 129 may upwardly diffuse light emitted from the light assembly 124.

The optical sheet 125 may be positioned at a front surface of the diffusion plate 129. A back surface of the optical sheet 125 may be adhered to the diffusion plate 129, and a front surface of the optical sheet 125 may be adhered to the back surface of the display panel 110.

The optical sheet 125 may include at least one sheet. More specifically, the optical sheet 125 may include one or more prism sheets and/or one or more diffusion sheets. The plurality of sheets included in the optical sheet 125 may be attached and/or adhered to one another.

In other words, the optical sheet 125 may include a plurality of sheets having different functions. For example, the optical sheet 125 may include first to third optical sheets 125a to 125c. The first optical sheets 125a may function as a diffusion sheet, and the second and third optical sheets 125b and 125c may function as a prism sheet. A number and/or a position of the diffusion sheets and the prism sheets may be changed. For example, the optical sheet 125 may include the first optical sheets 125a as the diffusion sheet and the second optical sheet 125b as the prism sheet.

The diffusion sheet may prevent light coming from the diffusion plate from being partially concentrated and may homogenize a luminance of the light. The prism sheet may concentrate light coming from the diffusion sheet and may make the concentrated light be vertically incident on the display panel 110.

The coupling unit 125d may be formed on at least one of corners of the optical sheet 125. The coupling unit 125d may be formed in at least one of the first to third optical sheets 125a to 125c.

The coupling unit 125d may be formed at the corner on the long side of the optical sheet 125. The coupling unit 125d formed on the first long side and the coupling unit 125d formed on the second long side may be asymmetric. For example, a number and/or a position of the coupling units 125d formed on the first long side may be different from a number and/or a position of the coupling units 125d formed on the second long side.

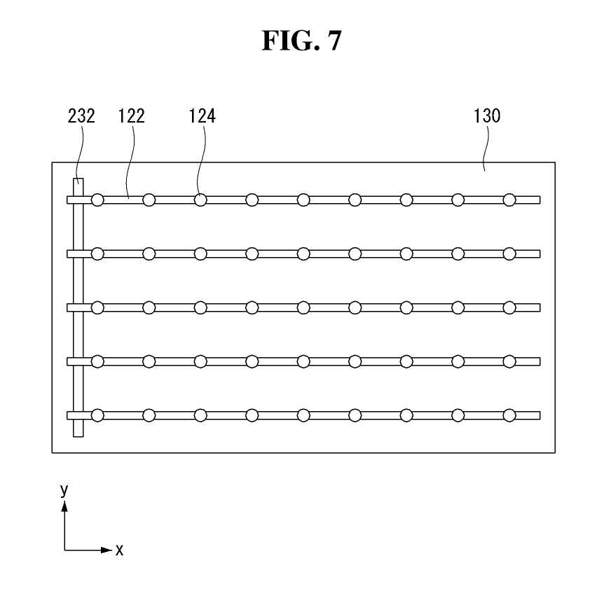

Referring to FIG. 7, the substrate 122 including the plurality of straps, which extend in the first direction and are separated from one another by a predetermined distance in the second direction perpendicular to the first direction, may be provided on the frame 130. One end of each of the plurality of substrates 122 may be connected to a line electrode 232.

The line electrode 232 may extend in the second direction. The line electrode 232 may be connected to the ends of the substrates 122 at predetermined intervals in the second direction. The substrates 122 may be electrically connected to the adaptor through the line electrode 232.

The light assemblies 124 may be mounted on the substrate 122 at predetermined intervals in the first direction. A diameter of the light assembly 124 may be greater than a width of the substrate 122 in the second direction. Hence, an outer area of the light assembly 124 may be positioned beyond a formation area of the substrate 122.

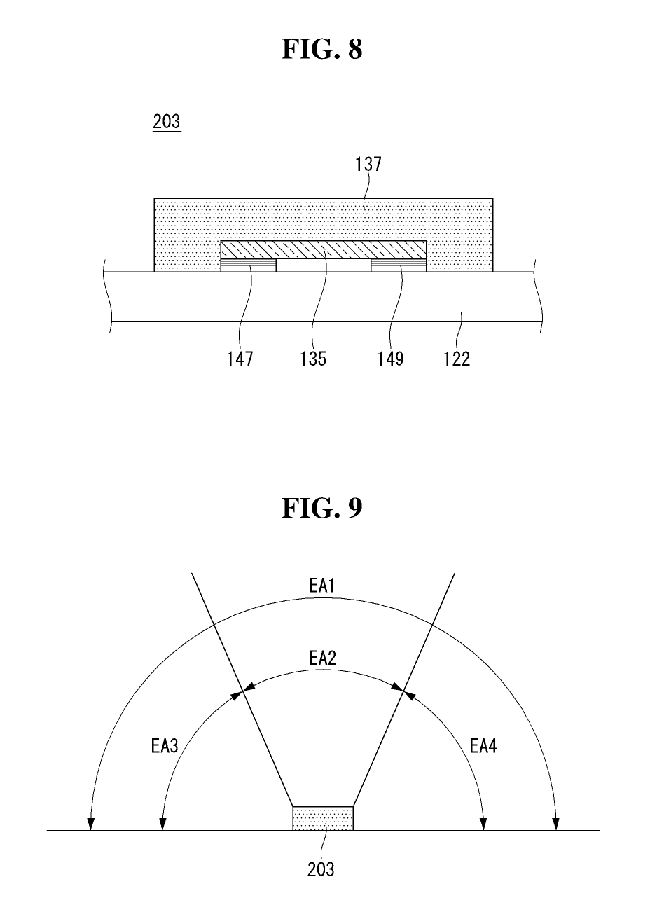

FIGS. 8 and 9 show a light source according to the embodiment of the invention.

As shown in FIG. 8, a light source 203 may be a COB light source. The COB light source 203 may include at least one of an emission layer 135, first and second electrodes 147 and 149, and a fluorescent layer 137.

The emission layer 135 may be positioned on the substrate 122. The emission layer 135 may emit one of red, green, and blue light. The emission layer 135 may include one of Firpic, (CF3ppy)2Ir(pic), 9,10-di(2-naphthyl)anthracene(AND), perylene, distyrybiphenyl, PVK, OXD-7, UGH-3(Blue), and a combination thereof.

The first and second electrodes 147 and 149 may be positioned on both sides of a lower surface of the emission layer 135. The first and second electrodes 147 and 149 may transmit an external driving signal to the emission layer 135.

The fluorescent layer 137 may cover the emission layer 135 and the first and second electrodes 147 and 149. The fluorescent layer 137 may include a fluorescent material converting light of a spectrum generated from the emission layer 135 into white light. A thickness of the emission layer 135 on the fluorescent layer 137 may be uniform. The fluorescent layer 137 may have a refractive index of 1.4 to 2.0.

The COB light source 203 according to the embodiment of the invention may be directly mounted on the substrate 122. Thus, the size of the light assembly 124 may decrease.

Because heat dissipation of the light sources 203 is excellent by forming the light sources 203 on the substrate 122, the light sources 203 may be driven at a high current. Hence, a number of light sources 203 required to secure the same light quantity may decrease.

Further, because the light sources 203 are mounted on the substrate 122, a wire bonding process may not be necessary. Hence, the manufacturing cost may be reduced due to the simplification of the manufacturing process.

As shown in FIG. 9, the light source 203 according to the embodiment of the invention may emit light in a first emission range EA1. Namely, the light source 203 may emit light in the first emission range EA1 including a second emission range EA2 of the front side and third and fourth emission ranges EA3 and EA4 of both sides. Thus, the light source 203 according to the embodiment of the invention is different from a related art POB light source emitting light in the second emission range EA2. In other words, the light source 203 according to the embodiment of the invention may emit light in a wide emission range including the side.

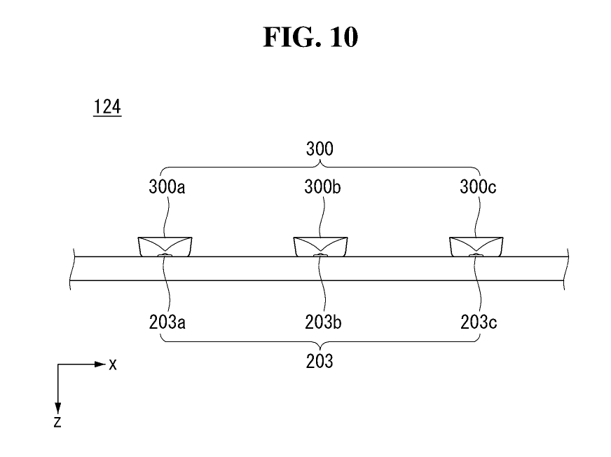

FIG. 10 shows a light assembly including a light source shown in FIG. 9.

As shown in FIG. 10, a plurality of light assemblies 124 according to the embodiment of the invention may be disposed along the substrate 122 and separated from one another. The light assembly 124 may include a light source 203 and a lens 300 positioned on one side of the light source 203.

The light source 203 may be various sources emitting light. For example, the light source 203 may be a COB type LED as described above.

The lens 300 may be positioned on the light source 203. At least a partial area of the light source 203 may overlap the lens 300. For example, the light source 203 may be inserted into a groove inside the lens 300. Alternatively, an area of the light source 203, from which light is substantially emitted, may be inserted into the lower side of the lens 300. For example, when the lens 300 has a leg structure, a portion of the upper side of the light source 203 may be inserted into the lower side of the lens 300.

The lens 300 may reflect a portion of light emitted from the light source 203 and may refract a portion of the light. For example, the lens 300 may be a refractive lens or a reflective lens. The light emitted from the light source 203 may be uniformly and entirely diffused through the reflection in a portion of the lens 300 and/or the refraction in a portion of the lens 300.

The light source 203 inserted into the lens 300 may be adhered to the lens 300. For example, the lens 300 and the light source 203 may be attached to each other using an adhesive.

The lens 300 may correspond to each light source 203. For example, first to third lenses 300a to 300c may be respectively positioned on first to third light sources 203a to 203c.

The lens 300 may control a path of light emitted from the light source 203. Namely, the lens 300 may control the light source 203 so that the light of the light source 203 is not concentrated on a specific location. In other words, the lens 300 may cause the light of the light source 203 to be uniformly diffused. The lens 300 according to the embodiment of the invention may efficiently control the path of the light of the light source 203. The lens 300 according to the embodiment of the invention may efficiently control light emitted from the side of the light source 203.

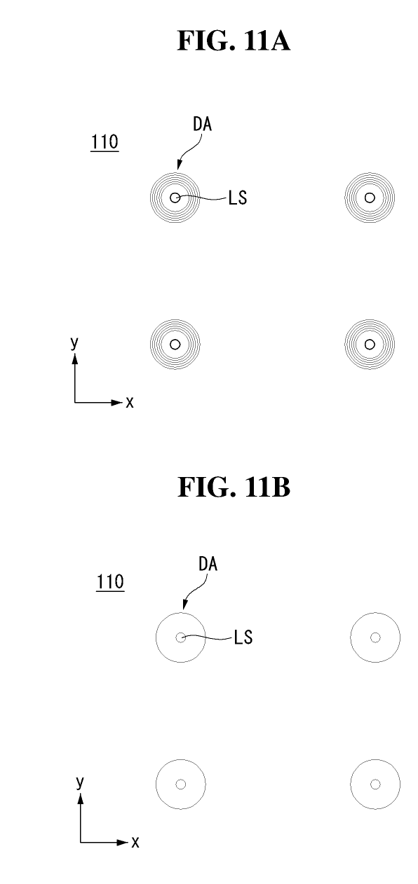

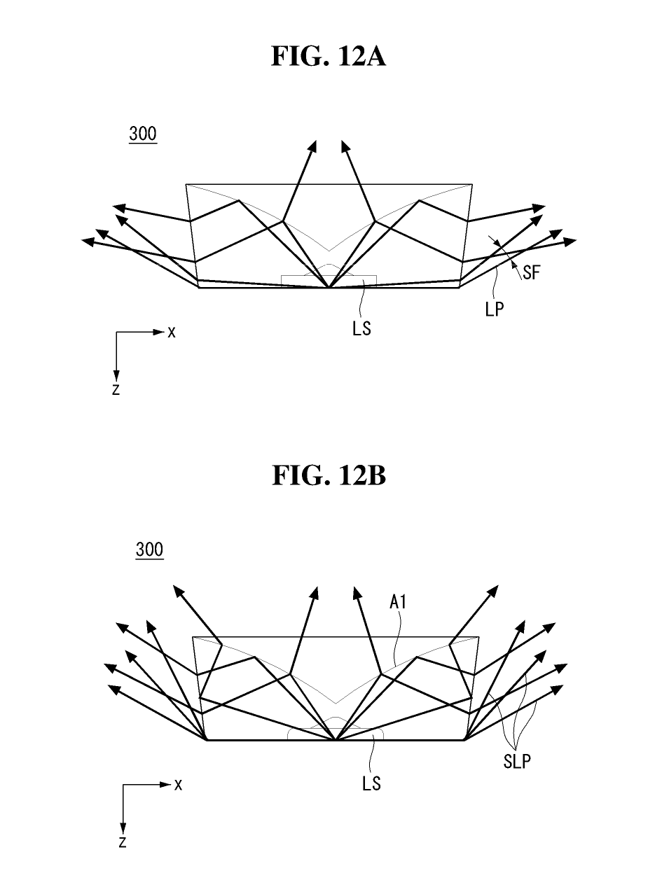

FIGS. 11 and 12 show a difference between lenses constituting a light assembly.

As shown in FIGS. 11 and 12, the light assembly 124 according to the embodiment of the invention may efficiently control an optical path.

FIG. 11 shows a brightness difference of the display panel 110 depending on the control of an optical path.

As shown in FIG. 11A, when the control of the optical path is not effective, a shadow portion DA may be formed around a light spot LS corresponding to each light source 203. When there is a large difference (i.e., contrast) between a brightness of the light spot LS and a brightness of the shadow portion DA, image quality may be reduced.

As shown in FIG. 11B, when the optical path is effectively controlled, a brightness difference (i.e., contrast) between a light spot LS and a shadow portion DA corresponding to each light source 203 may relatively reduced. Namely, a brightness difference recognized through the display panel 110 may be not generated or may be slightly generated.

As shown in FIG. 12A, the lens 300 may affect a path LP of light emitted from the light spot LS. When the COB light source is used, an amount of light emitted from the side of the light source may increase compared to the related art, as described above. A path LP of light emitted from the side of the light source may form a concentration area SF. Namely, when side light of the light source is not efficiently controlled, the path LP of the side light of the light source may form the concentration area SF. The concentration area SF may make a contrast between the light source and an area around the light source.

As shown in FIG. 12B, the lens 300 according to the embodiment of the invention may effectively control a path of light emitted from the light spot LS. In particular, the lens 300 according to the embodiment of the invention may effectively control a path SLP of side light emitted from the side of the light spot LS. For example, when side light is emitted from the side of the COB light source, the path SLP of the side light may be dispersed in various directions. Hence, a contrast resulting from the side light may be minimized.

As described above, the lens 300 may be a refractive lens or a reflective lens. For example, at least a portion of light emitted from the upper side of the lens 300 may be refracted or reflected due to a shape of a first concave portion A1. The light may be uniformly distributed to the outside of the lens 300 by the refraction or the reflection from the first concave portion A1. The lens 300 having the above-described configuration can obtain an effect different from a related art lens, which mainly used the refraction of light.

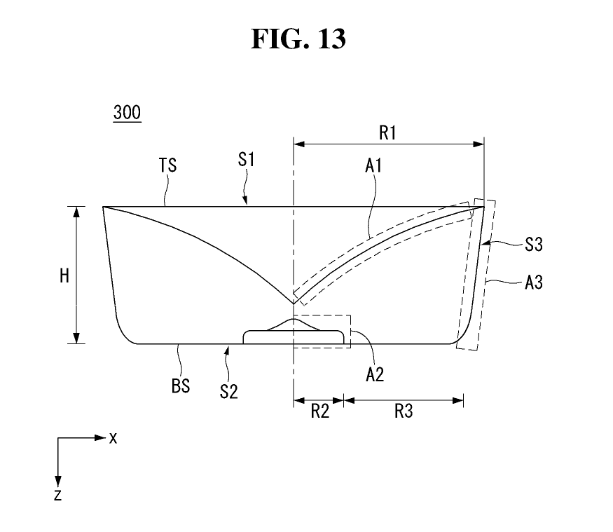

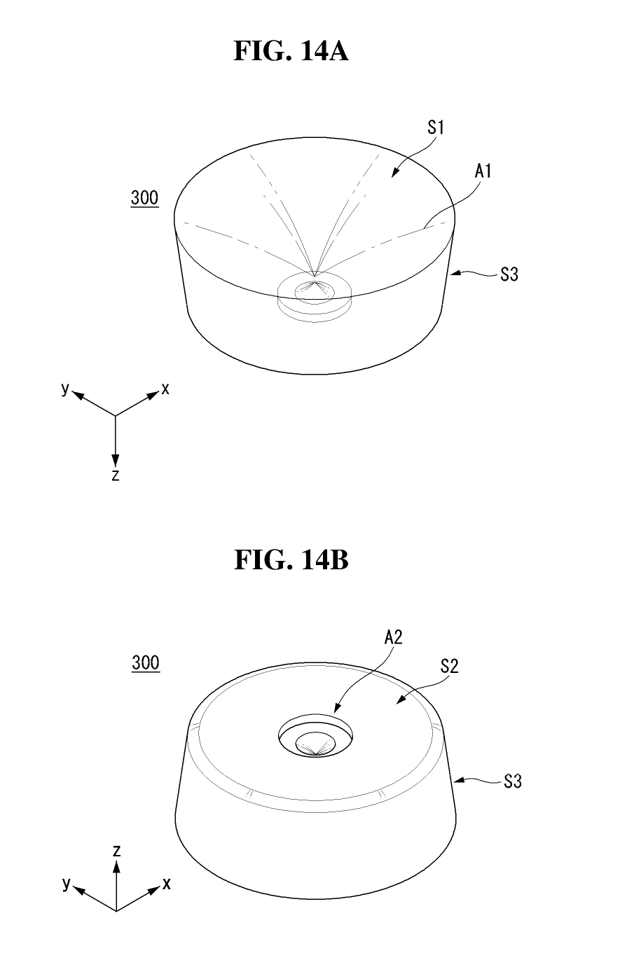

FIGS. 13 and 14 show a lens according to the embodiment of the invention.

As shown in FIGS. 13 and 14, a lens 300 according to the embodiment of the invention may have a specific shape.

As shown in FIG. 13, the lens 300 may include a first surface S1, a second surface S2 opposite the first surface S1, and a third surface S3 connecting the first surface S1 and the second surface S2.

The first surface S1 may be an upper part or an upper side of the lens 300. At least a portion of the first surface S1 of the lens 300 according to the embodiment of the invention may be depressed. A depressed portion of the first surface S1 may have a shape curved from the center of the lens 300 to the outside of the lens 300. For example, a first concave portion A1 may be formed on the first surface S1.

An uppermost area of the first surface S1 may be referred as a top surface TS. The first surface S1 may have a circular shape. Light emitted from the upper side of the light source 203 may be upwardly emitted through the first surface S1 of the lens 300.

The second surface S2 may be a lower part or a lower side of the lens 300. Namely, the second surface S2 may be a surface opposite the first surface S1 corresponding to the upper part of the lens 300. At least a portion of the second surface S2 of the lens 300 according to the embodiment of the invention may be depressed. For example, a second concave portion A2 may be formed on the second surface S2.

A radius of the second concave portion A2 on the second surface S2 may be denoted as R2. The radius R2 of the second concave portion A2 may be 1.5 to 4 times a radius of the light source 203 coupled to the lens 300.

A lowermost area of the second surface S2 may be referred to as a bottom or a bottom surface BS. The second surface S2 may have a circular shape. The light source 203 may be coupled to the second surface S2. As described above, a portion of the light source 203 may be inserted into the second surface S2.

A radius of the second surface S2 may be “R2+R3”. A radius R1 of the first surface S1 may be 1 to 3 times the radius (R2+R3) of the second surface S2. Namely, a width of the top surface TS may be greater than a width of the bottom surface BS.

The radius (R2+R3) of the second surface S2 may be 2 to 4 times a radius R2 of the second concave portion A2.

The third surface S3 may be a surface connecting the first surface S1 and the second surface S2. Namely, the third surface S3 may be a side surface connecting the upper surface and the lower surface of the lens 300. The first surface S1 and the second surface S2 each have the circular shape, and the third surface S3 forms an outer surface connecting the first surface S1 and the second surface S2. Therefore, the lens 300 may have an outline of a cylindrical shape having a height H. In the cylindrical shape of the lens 300, at least a portion of the first to third surfaces S1 to S3 may be changed.

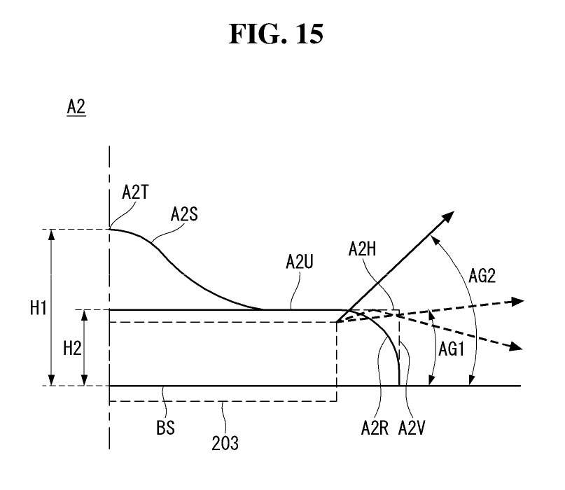

FIGS. 15 to 19 show a second concave portion of the lens shown in FIG. 13.

As shown in FIGS. 15 to 19, the second surface S2 of the lens 300 according to the embodiment of the invention may have a predetermined shape, so as to efficiently control a path of light emitted from the side of the light source. Namely, the second concave portion A2 may be formed in the center of the second surface S2.

FIG. 15 shows a half of the second concave portion A2 based on the center of the lens 300. As shown in FIG. 15, the second concave portion A2 may include a center point A2T, a first area A2S obliquely extending from the center point A2T toward the outside of the second surface S2, a second area A2U extending from the first area A2S in substantially parallel with the bottom surface BS of the second surface S2, and a third area A2R extending from the second area A2U to the bottom surface BS of the second surface S2.

The center point A2T may be a center point of the lens 300 and/or a center point of the second concave portion A2. The center point A2T may be a location, at which a groove of the second concave portion A2 has a maximum height and/or a maximum depth. The second concave portion A2 may have a shape falling from the center point A2T.

The first area A2S may have a shape obliquely falling from the center point A2T.

The second area A2U may be an area extending from the first area A2S. The second area A2U may be substantially parallel with the bottom surface BS of the second surface S2. For example, the second area A2U may have a shape capable of maintaining a height H2 from the bottom surface BS to the second area A2U.

At least a portion of the light source 203 may be positioned in the second area A2U, the first area A2S, and/or the center point A2T. For example, an area of the light source 203 emitting light may overlap the inside of the lens 300.

The third area A2R may be an area extending from the second area A2U. More specifically, the third area A2R may extend from the second area A2U to the bottom surface BS of the second surface S2.

The third area A2R may have a curved surface toward the center of the second surface S2. Namely, a boundary between the second area A2U and the third area A2R may be rounded.

The third area A2R may be an area transmitting the side light emitted from the light source 203. The round shape of the third area A2R may be suitable to disperse the side light emitted from the light source 203.

When the third area A2R includes a linear horizontal area A2H and a linear vertical area A2V, the side light may be emitted in a path of a first dispersion angle AG1. For example, light, which relatively upwardly travels among light emitted from the light source 203, may be totally reflected from an inner surface of the horizontal area A2H and cannot be upwardly emitted.

When the third area A2R according to the embodiment of the invention is configured as the round shape, the side light may be dispersed along the round shape of the third area A2R. Namely, the side light may be more widely emitted to the outside in a path of a second dispersion angle AG2 greater than the first dispersion angle AG1. Because the embodiment of the invention can disperse the side light, the contrast resulting from the concentration of light may be reduced.

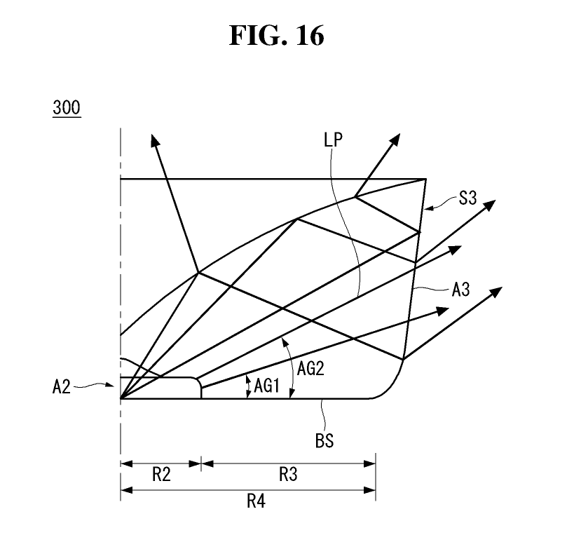

As shown in FIG. 16, side light may be dispersed due to a shape of the second concave portion A2. Namely, the side light may be dispersed in the path of the second dispersion angle AG2 greater than the related art first dispersion angle AG1. Hence, the concentration of light may be reduced.

A radius of a bottom surface of the lens 300 may be denoted as R4. A radius of the second concave portion A2 may be denoted as R2. The radius R4 may be 2 to 4 times the radius R2.

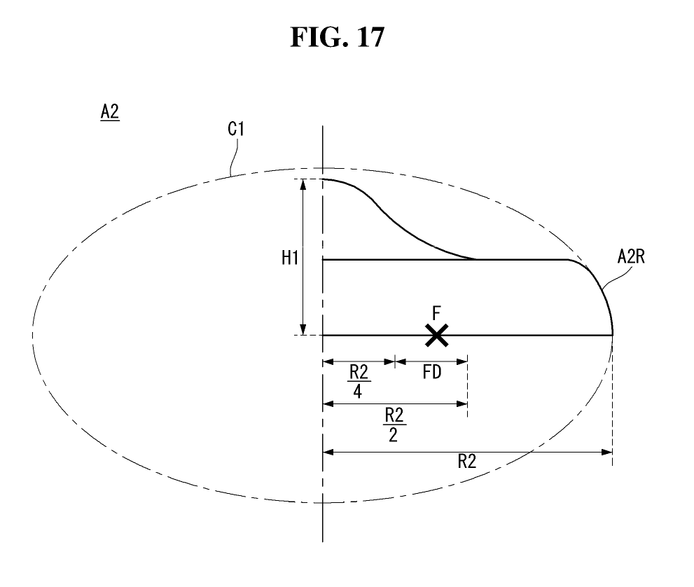

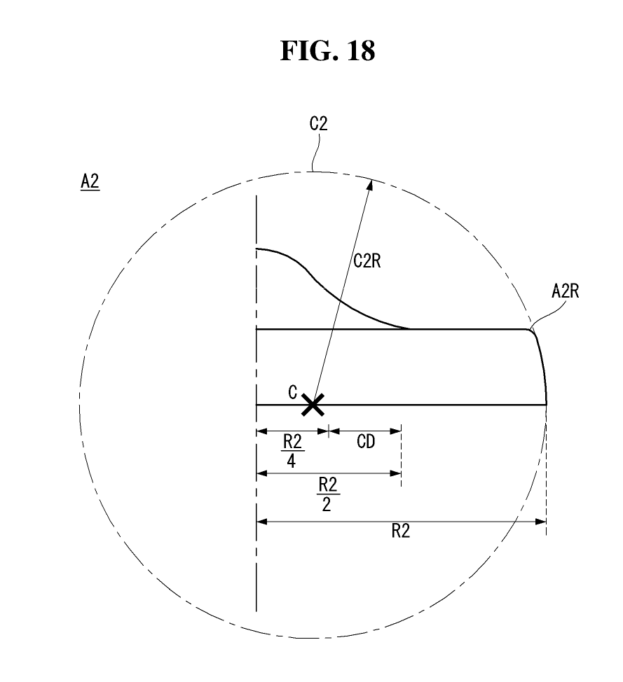

FIGS. 17 and 18 show a shape of the third area A2R of the second concave portion A2.

As shown in FIG. 17, the third area A2R may be a curved surface. The third area A2R of the curved surface may be formed along a trace of a circle. Alternatively, the third area A2R of the curved surface may be formed along a trace of an oval.

An oval, i.e., a first circle C1 determining a shape of the third area A2R may use a predetermined position as a focus F. For example, when a radius of the second concave portion A2 is R2, the focus F may be positioned between ¼ (R2/4) and ½ (R2/2) of R2. Namely, the third area A2R may be formed along a trace of the oval, in which the focus F exists at a predetermined position of a focus area FD. The shape of the third area A2R may change depending on a position of the focus F inside the focus area FD.

As shown in FIG. 18, the third area A2R may be determined by a shape of a circle having a point C positioned between ¼ (R2/4) and ½ (R2/2) of the radius R2 of the second concave portion A2 as the center. Namely, the third area A2R may be determined by a shape of an arc of an imaginary circle having the center C.

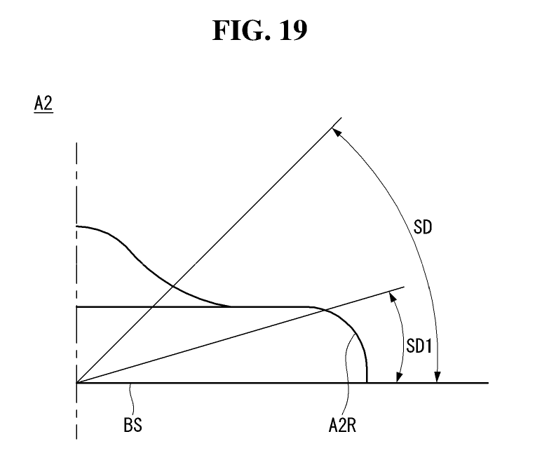

As shown in FIG. 19, the third area A2R may be positioned in a predetermined area from the bottom surface BS. The predetermined area may be positioned within the range of an angel SD from the bottom surface BS. The angel SD may be 45°. For example, the third area A2R may be determined based on an angel SD1 between 0° and 45°.

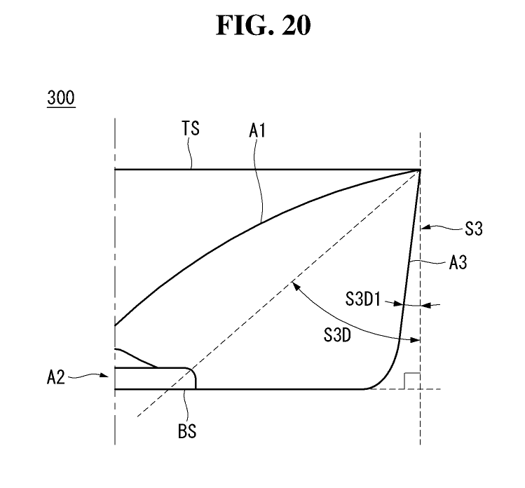

FIGS. 20 to 22 show a third surface of the lens shown in FIG. 13.

As shown in FIGS. 20 to 22, a third surface S3 according to the embodiment of the invention may exist in a previously set area.

As shown in FIG. 20, the third surface S3 may be positioned between the top surface TS and the bottom surface BS.

The third surface S3 may entirely have a shape inclined from a vertical line by a predetermined angle. The predetermined angle may be within the range of an angle S3D from a vertical line starting at a boundary point TSE between the first surface S1 and the third surface S3. The angle S3D may be between 0° and 60°. For example, the third surface S3 may be formed along an angle S3D1 less than the angle S3D.

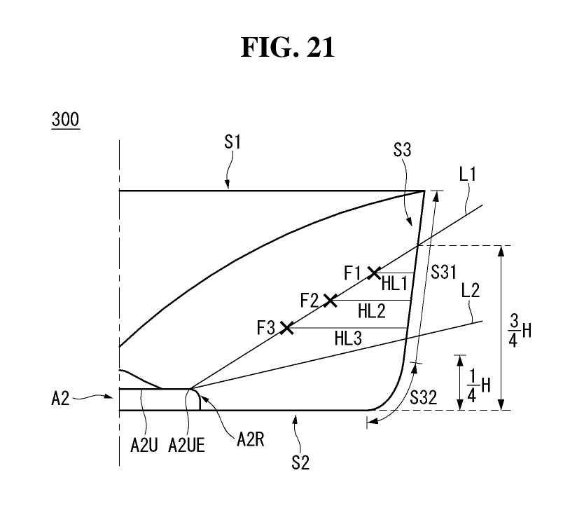

As shown in FIG. 21, the third surface S3 may include a straight surface S31 and a curved surface S32.

The straight surface S31 may extend from the boundary point TSE toward the second surface S2.

The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. For example, an imaginary line L1, which uses a boundary between the second area A2U and the third area A2R of the second concave portion A2 as a starting point and connects ¼ (1H/4) to ¾ (3H/4) of a height H of the lens 300, may be set. Imaginary horizontal lines HL1, HL2, and HL3 of the third surface S3 may be set. The curved surface S32 may have a shape corresponding to an arc contacting an imaginary oval using one of intersection points F1, F2, and F3 between the imaginary line L1 and the imaginary horizontal lines HL1, HL2, and HL3 as a focus.

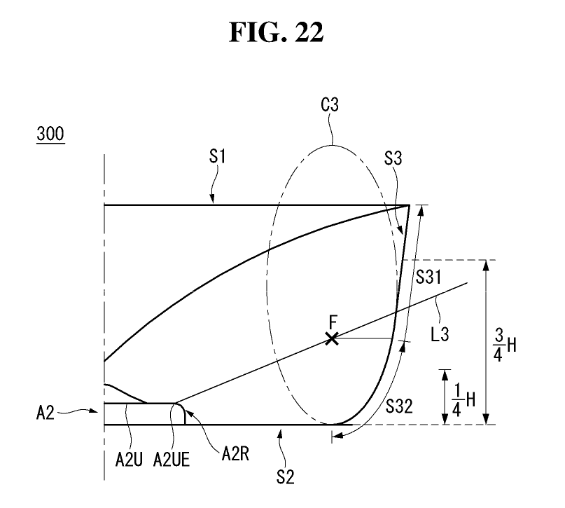

As shown in FIG. 22, a curved surface S32 contacting a portion of an imaginary third oval C3 using an intersection point F as a focus may be set. A shape of the curved surface S32 may be changed by changing at least one of the imaginary line L1, the horizontal lines HL1, HL2, and HL3, and the intersection points F1, F2, and F3.

A curvature of the curved surface S32 may be different from a curvature of the third area A2R. Namely, a curvature of the side of the second concave portion A2 may be different from a curvature of the side of the third surface S3. Because a curvature of the inside of the lens 300 is different from a curvature of the outside of the lens 300, a path of light emitted from the light source may be further diversified. Namely, light emitted from the light source is not concentrated at a specific location or a specific area and may be uniformly radiated.

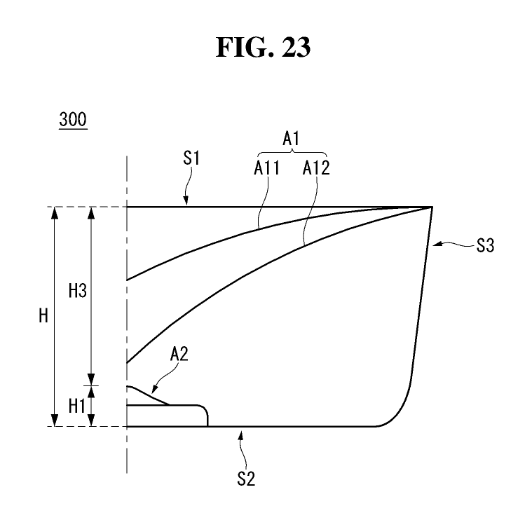

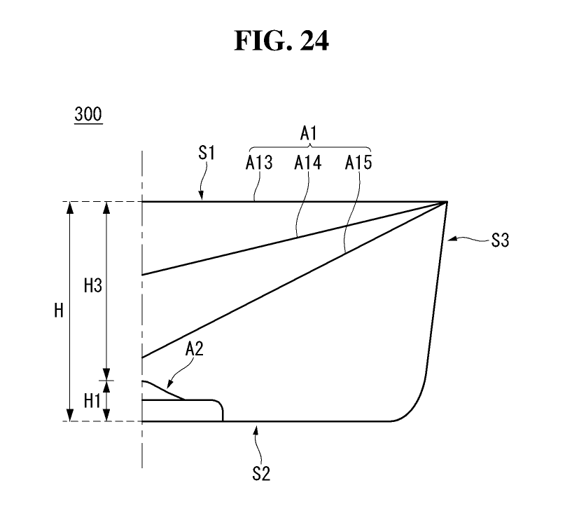

FIGS. 23 and 24 show a first area of the lens shown in FIG. 13.

As shown in FIGS. 23 and 24, a first concave portion A1 may be formed on the first surface S1 of the lens 300 according to the embodiment of the invention.

The first concave portion A1 may have a shape, in which the first surface S1 is depressed toward the second surface S2. For example, a center portion of the lens 300 has a maximum depression depth, a center point, and a depression depth of the lens 300 may decrease as the lens 300 goes from the center portion to an outer portion.

When a height of the second concave portion A2 of the lens 300 is denoted as H1, a maximum depression position of the first concave portion A1 may be other portion except a portion having the height H1. Namely, the maximum depression position of the first concave portion A1 may exist in a portion having a height H3.

The first concave portion A1 may have a curved shape. For example, the first concave portion A1 may have a predetermined curved shape, as in a 1a concave portion A11 and a 1b concave portion A12.

As shown in FIG. 24, the first concave portion A1 of a linear shape may be formed on the first surface S1 of the lens 300 according to the embodiment of the invention. For example, 1c to 1e concave portions A13 to A15, of which a depression depth gradually decreases linearly from the maximum depression position (center point) of the first concave portion A1, may be formed.

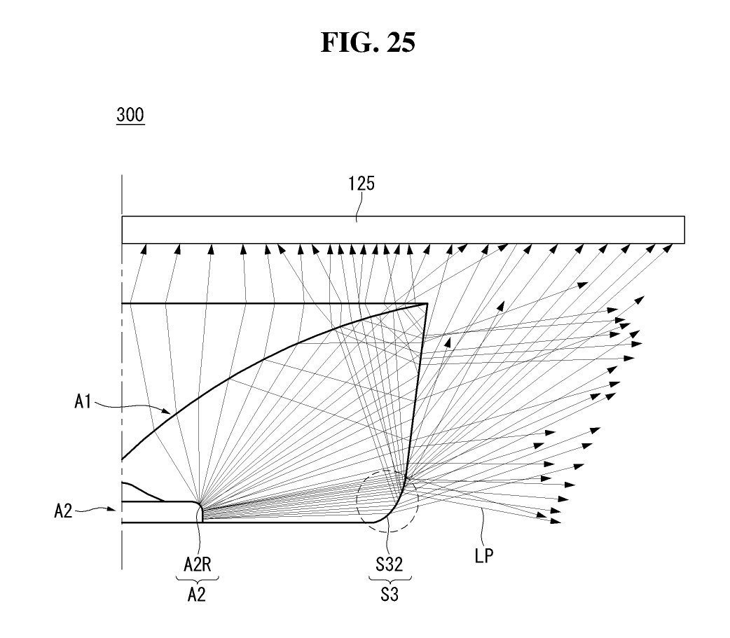

FIG. 25 shows an example of an optical path due to the lens shown in FIG. 13.

As shown in FIG. 25, the lens 300 according to the embodiment of the invention may control a path LP of light and may cause the light to be uniformly transferred to the optical sheet 125. In particular, the lens 300 according to the embodiment of the invention may change the path LP of light emitted from the side of the light source 203.

The light emitted from the side of the light source 203 may be firstly diffused from the second concave portion A2. Namely, as described above, the light path LP may be radiated due to a shape of a third area A2R of the second concave portion A2.

The light path LP distributed from the side of the second concave portion A2 may be again radiated via a curved surface S32 of the third surface S3.

At least a portion of the light path LP passing through the second concave portion A2, etc., may be refracted and/or reflected from the first concave portion A1. Thus, the light path LP may be prevented from being concentrated on a specific location. As a result, light may be uniformly distributed on the optical sheet 125.

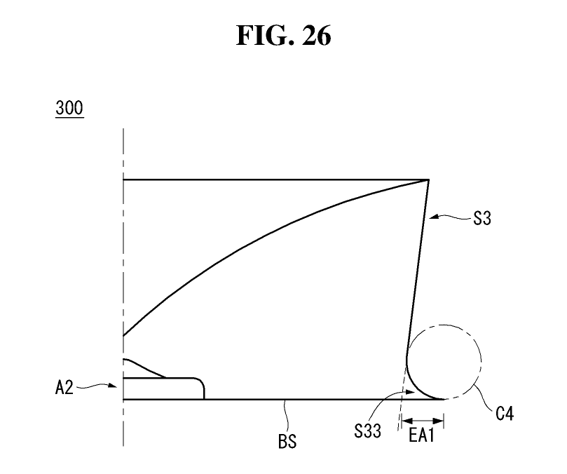

FIGS. 26 to 31 show a lens according to another example embodiment of the invention.

As shown in FIGS. 26 to 31, a lens 300 according to the embodiment of the invention may be variously configured.

As shown in FIG. 26, a curved surface S33 of a third surface S3 may have a shape protruding to the outside of the lens 300. For example, the curved surface S33 may form a curved surface S32 corresponding to an imaginary fourth circle C4 contacting an external surface of the third surface S3. The curved surface S33 may have the shape extending from a second surface S2 by a distance EA1.

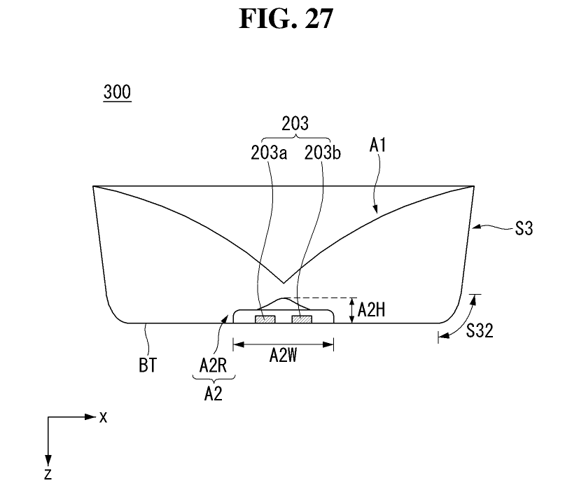

As shown in FIG. 27, the plurality of light sources 203 may correspond to one lens 300. For example, first and second light sources 203a and 203b may be positioned inside a second concave portion A2.

The light source 203 may have the relatively small size. The light source 203 may have a performance of high power. Thus, the first and second light sources 203a and 203b may correspond to one lens 300.

The second concave portion A2 may have an oval shape. For example, the second concave portion A2 may have the shape, in which a width A2W of the second concave portion A2 is greater than a height A2H of the second concave portion A2. The plurality of light sources 203a and 203b may be positioned in a space obtained by configuring the second concave portion A2 in the oval shape.

When the plurality of light sources 203 are positioned inside the second concave portion A2, the shape of the second concave portion A2 and/or the curved surface S32 of the third surface S3 may importantly operate in the embodiment of the invention. Namely, because a large amount of light may be generated from the sides of the first and second light sources 203a and 203b, it is necessary to more efficiently control the light emitted from the sides of the first and second light sources 203a and 203b. The embodiment of the invention may efficiently distribute the light emitted from the sides of the light sources through a curved third area A2R on the side of the second concave portion A2 and/or the curved surface S32 on the lower side of the third surface S3.

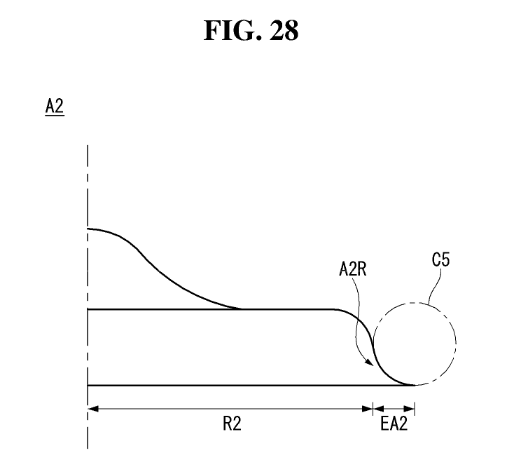

As shown in FIG. 28, the third area A2R of the second concave portion A2 may have the shape of a curved surface protruding to the outside of the lens 300. For example, the third area A2R may have the shape of the curved surface corresponding to an imaginary fifth circle C5 contacting the third area A2R of the second concave portion A2 outside the second concave portion A2. In this instance, a length of the second concave portion A2 may extend by a distance EA2.

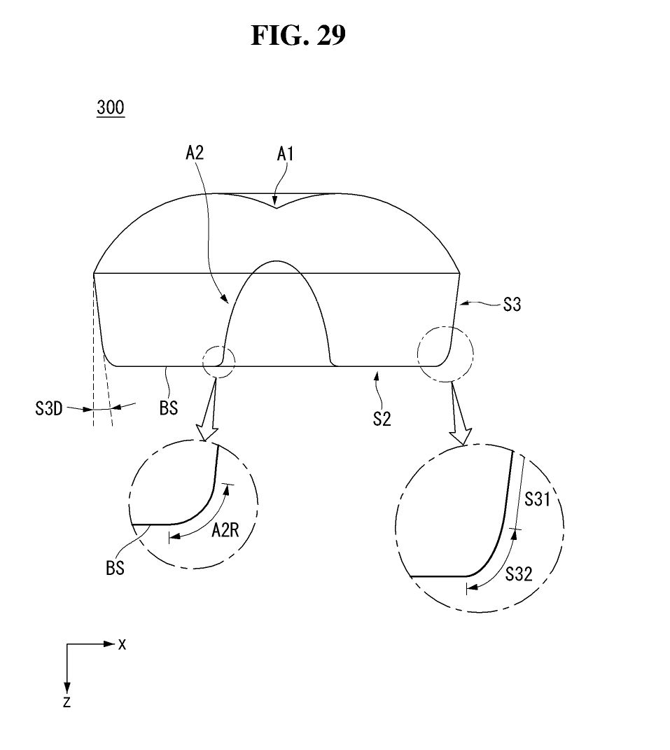

As shown in FIGS. 29 to 31, the embodiment of the invention may be applied to the lens 300, which may be configured in the various shapes.

As shown in FIG. 29, the third surface S3 may have a shape inclined at a predetermined angle. For example, the third surface S3 may have the shape inclined from the vertical line to the inside by an angle S3D.

The third surface S3 may include a straight surface S31 and a curved surface S32. The curved surface S32 may be connected to the second surface S2.

The third area A2R may be formed on the second concave portion A2. Namely, a curved surface may be formed in an area extending from the lower side of the second concave portion A2 to the bottom surface BS. The light emitted from the light source may be diffused due to the third area A2R. In particular, the third area A2R may improve the uniformity of the light emitted from the side of the light source.

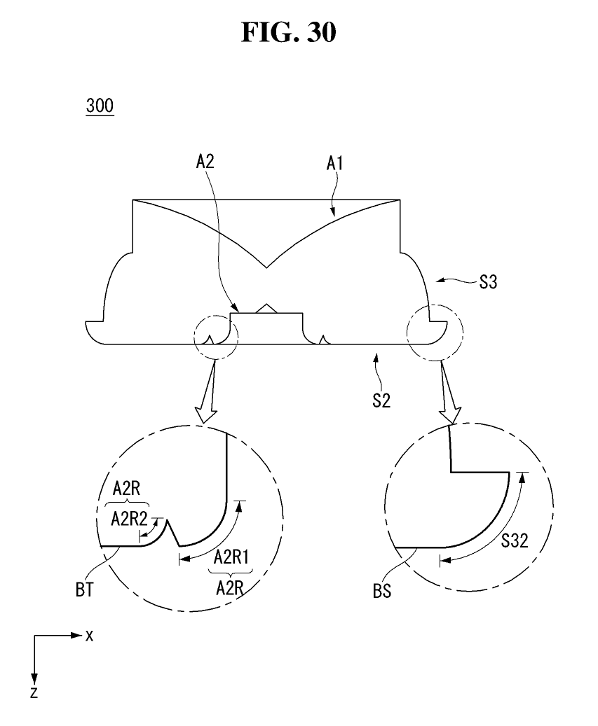

As shown in FIG. 30, a predetermined curved surface S32 may be formed in an area where the third surface S3 of the lens 300 and the bottom surface BS meet.

Third areas A2R1 and A2R2 may be formed on the second concave portion A2. Namely, a curved surface may be formed in a portion of an area where the second concave portion A2 and the bottom surface BS meet. The third areas A2R1 and A2R2 may include a 3a area A2R1 and a 3b area A2R2. Namely, a plurality of curved surfaces may be formed in a plurality of areas where the second concave portion A2 and the bottom surface BS meet.

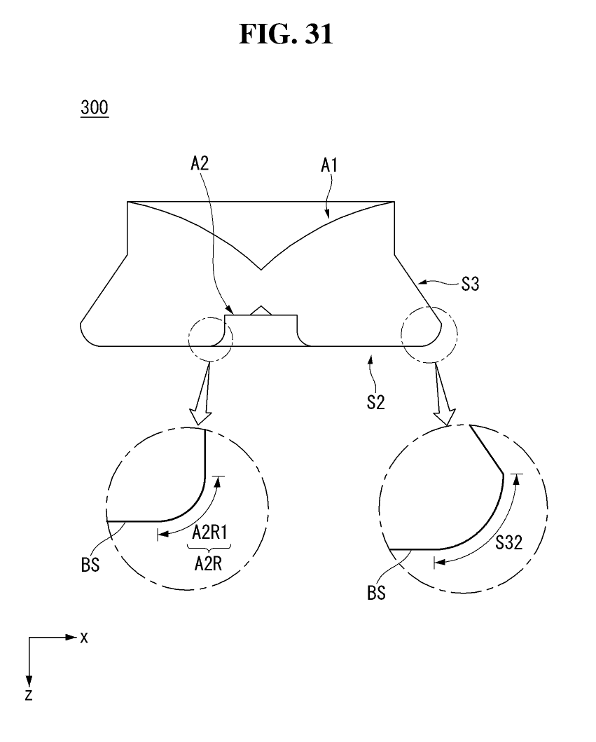

As shown in FIG. 31, a curved surface S32 may be formed in an area where the third surface S3 of the lens 300 and the bottom surface BS meet. The third area A2R of the curved surface may be formed on the second concave portion A2.

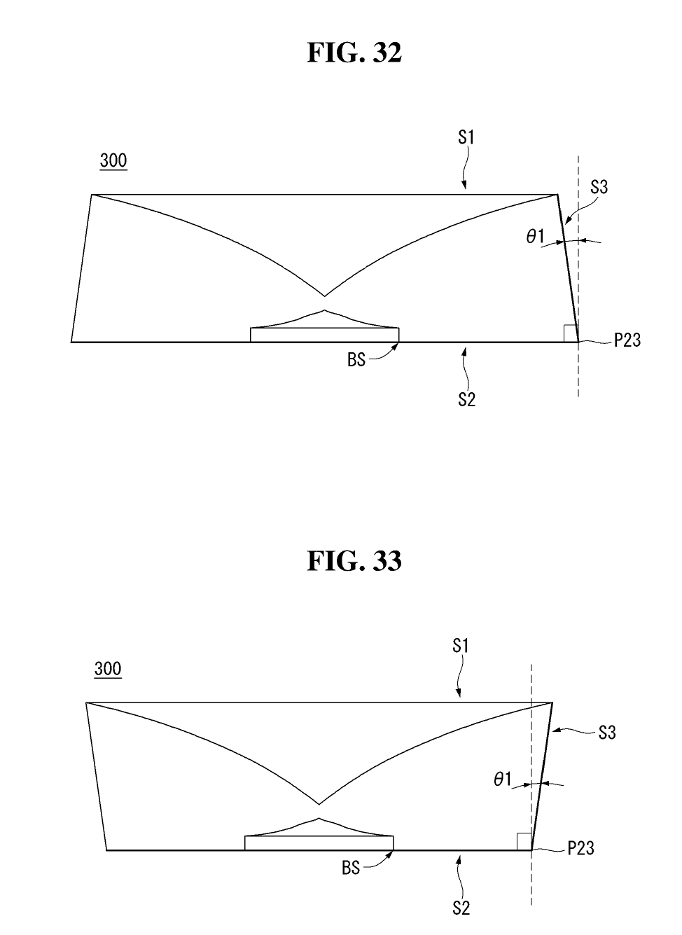

FIGS. 32 to 63 show a lens according to yet another example embodiment of the invention.

Referring to FIG. 32, a third surface S3 of a lens 300 according to the embodiment of the invention may have a shape entirely inclined from a vertical dotted line by a predetermined angle. The predetermined angle may be within the range of a predetermined angle θ1 from the vertical dotted line starting at a boundary point P23 between a second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

Referring to FIG. 33, the third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

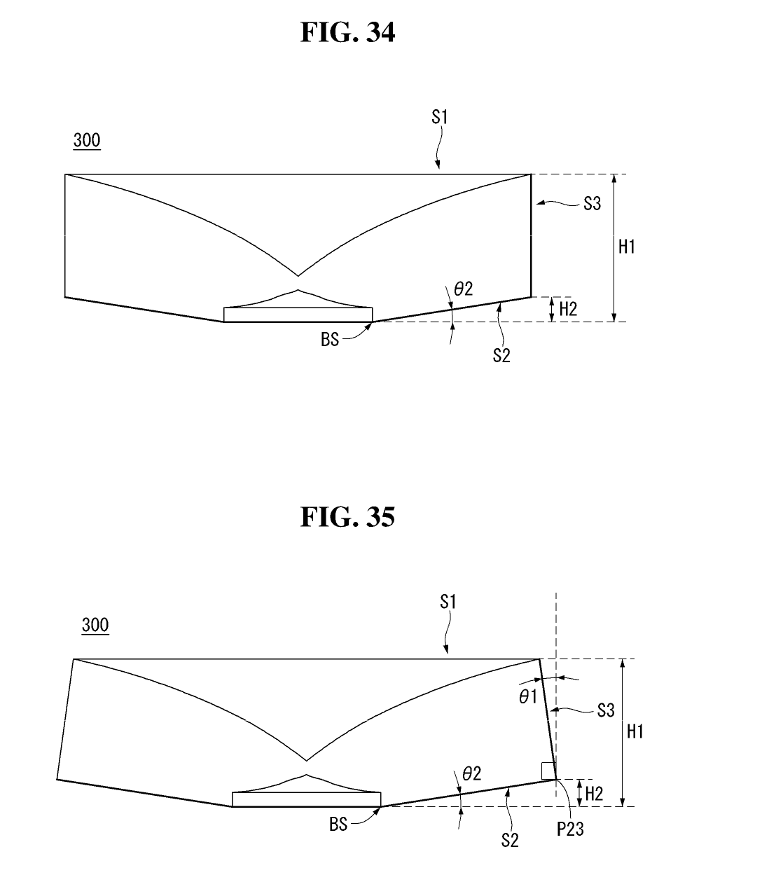

Referring to FIG. 34, the second surface S2 may be a lower surface of the lens 300. The second surface S2 may be inclined. In the embodiment disclosed herein, the inclination of the second surface S2 may have a predetermined angle θ2 with respect to a reference line extending from the above-noted bottom surface BS and may extend toward the third surface S3. Hereinafter, this is referred to as an inclined surface of the second surface S2.

The inclined surface of the second surface S2 may be flat. The fact that the inclined surface of the second surface S2 is flat may mean that the inclined surface of the second surface S2 entirely has a straight cross-sectional shape. The predetermined angle θ2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

Referring to FIG. 35, the inclined surface of the second surface S2 may be flat. The fact that the inclined surface of the second surface S2 is flat may mean that the inclined surface of the second surface S2 entirely has a straight cross-sectional shape. The predetermined angle θ2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

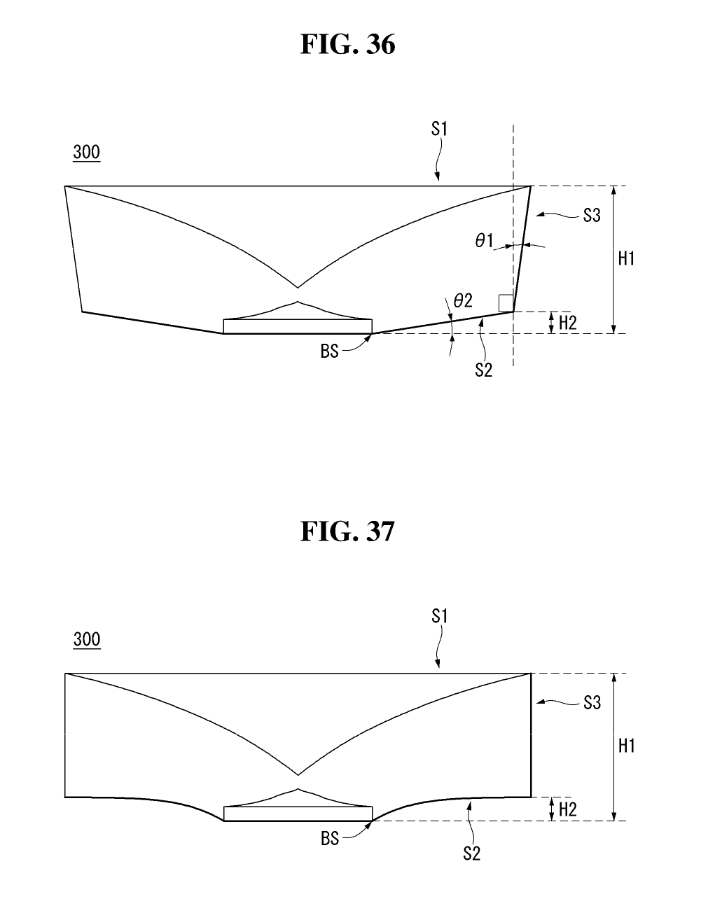

Referring to FIG. 36, the inclined surface of the second surface S2 may be flat. The fact that the inclined surface of the second surface S2 is flat may mean that the inclined surface of the second surface S2 entirely has a straight cross-sectional shape. The predetermined angle θ2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

Referring to FIG. 37, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

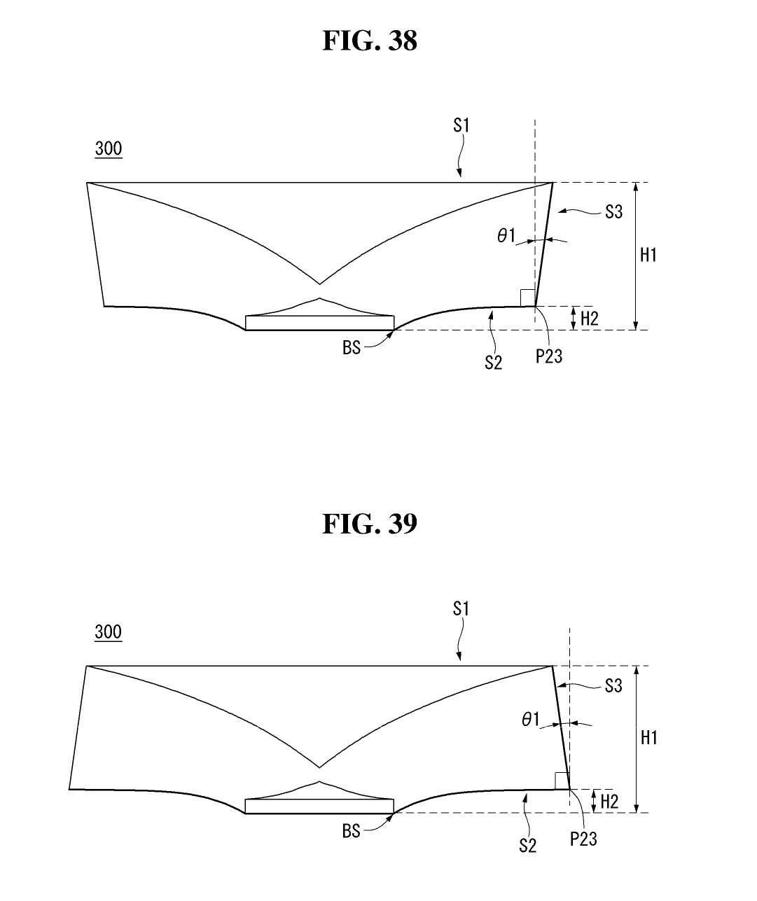

Referring to FIG. 38, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

Referring to FIG. 39, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

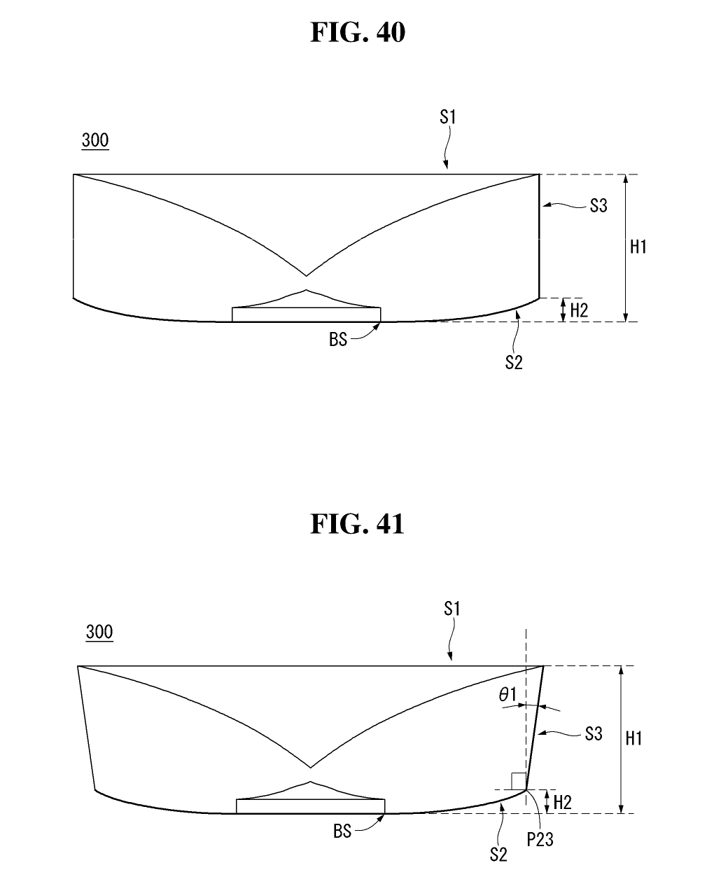

Referring to FIG. 40, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

Referring to FIG. 41, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

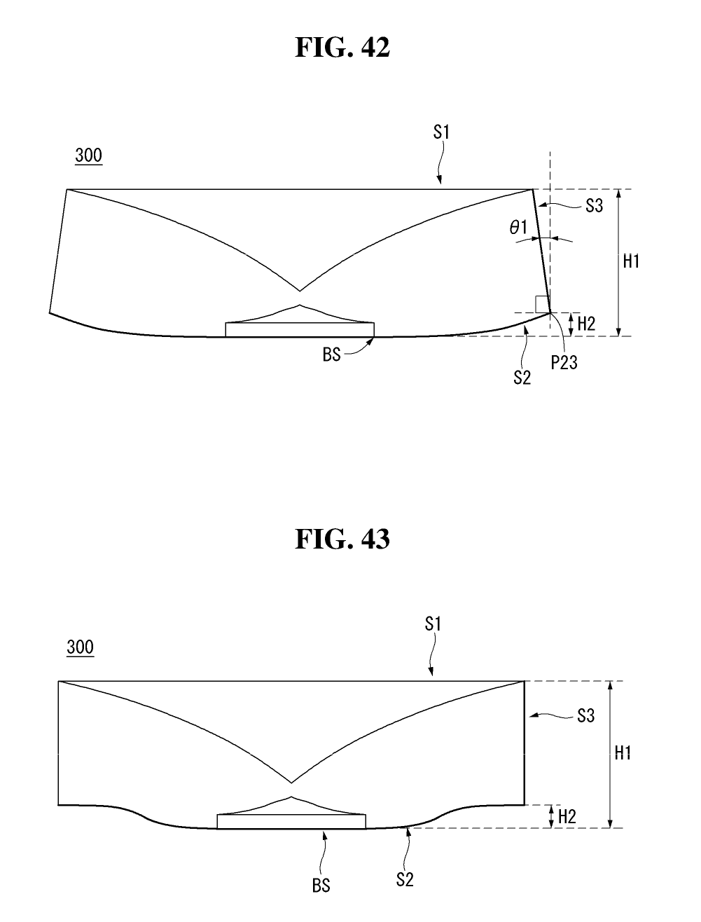

Referring to FIG. 42, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

Referring to FIG. 43, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

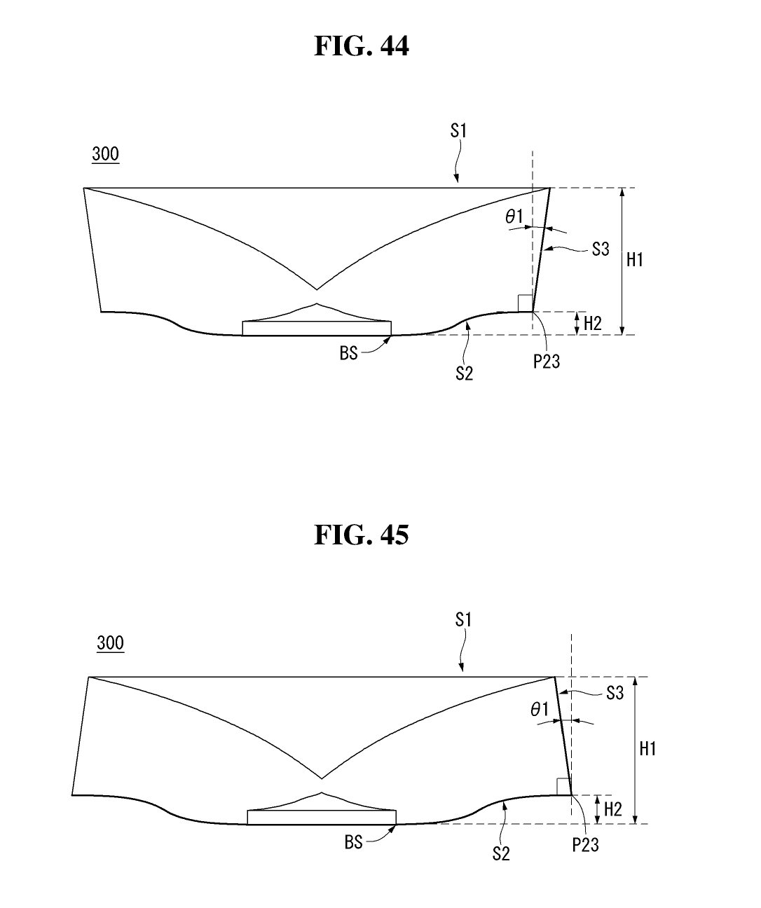

Referring to FIG. 44, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

Referring to FIG. 45, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

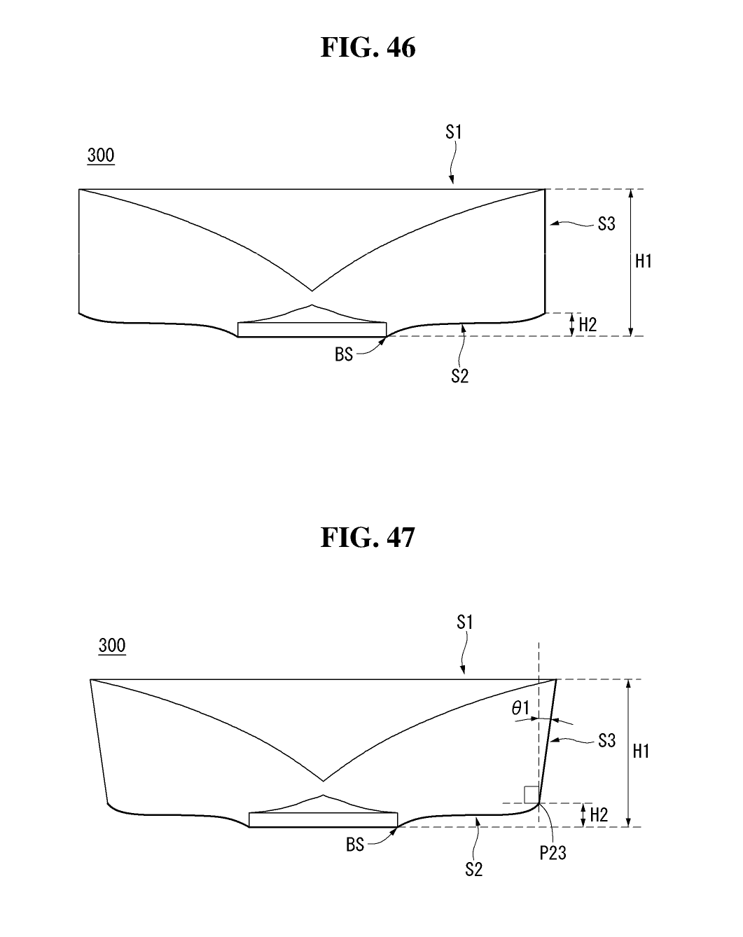

Referring to FIG. 46, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

Referring to FIG. 47, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

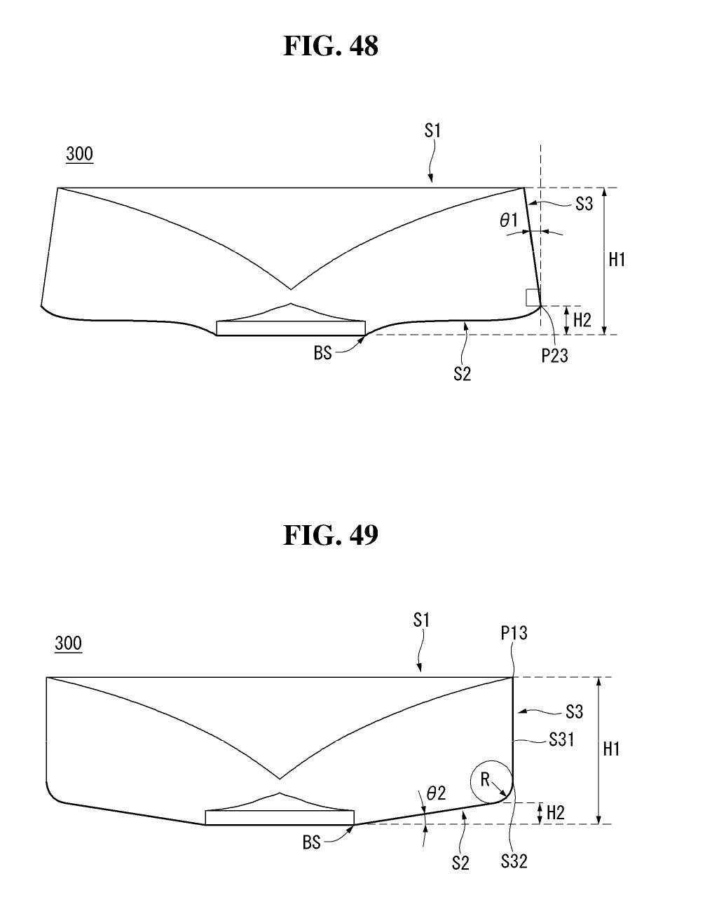

Referring to FIG. 48, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

Referring to FIG. 49, the inclined surface of the second surface S2 may be flat. The fact that the inclined surface of the second surface S2 is flat may mean that the inclined surface of the second surface S2 entirely has a straight cross-sectional shape. A predetermined angle θ2 with respect to the inclined surface of the second surface S2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

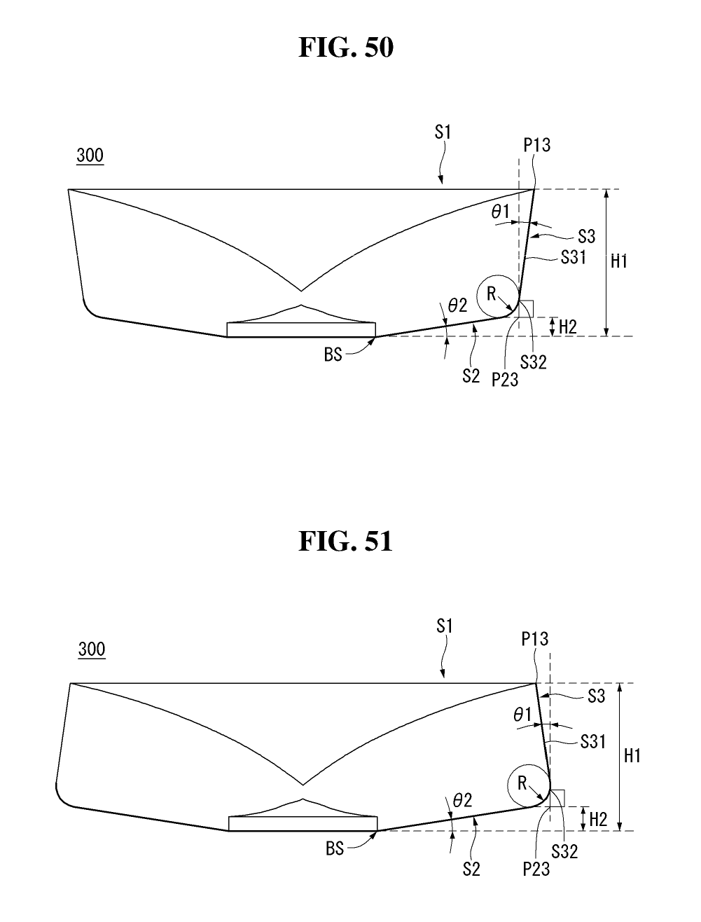

Referring to FIG. 50, the inclined surface of the second surface S2 may be flat. The fact that the inclined surface of the second surface S2 is flat may mean that the inclined surface of the second surface S2 entirely has a straight cross-sectional shape. A predetermined angle θ2 with respect to the inclined surface of the second surface S2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

Referring to FIG. 51, the inclined surface of the second surface S2 may be flat. The fact that the inclined surface of the second surface S2 is flat may mean that the inclined surface of the second surface S2 entirely has a straight cross-sectional shape. A predetermined angle θ2 with respect to the inclined surface of the second surface S2 may be equal to or less than 30°. When the predetermined angle θ2 is equal to or less than 30°, the control of light at the side of the lens 300 may be more efficiently performed. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

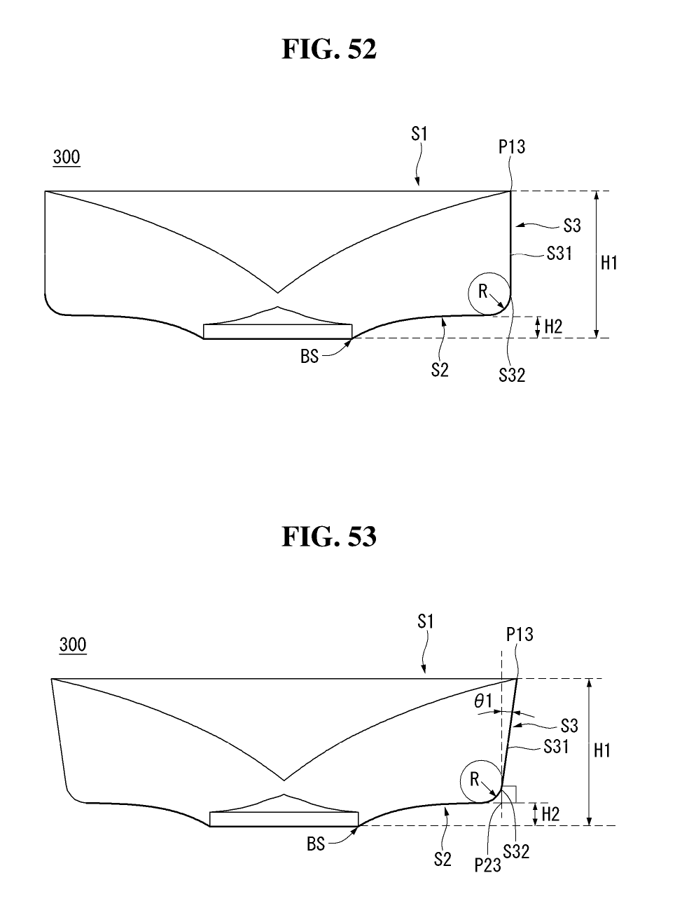

Referring to FIG. 52, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 53, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

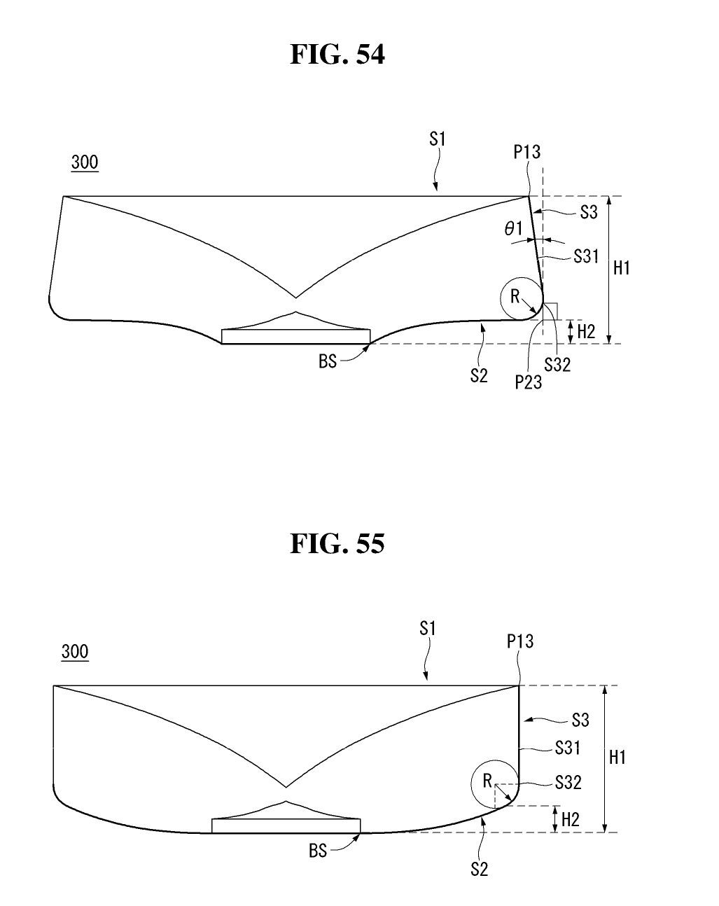

Referring to FIG. 54, the inclined surface of the second surface S2 may be curved. The fact that the inclined surface of the second surface S2 is curved may mean that the inclined surface of the second surface S2 entirely has a concave cross-sectional shape toward the inside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 55, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

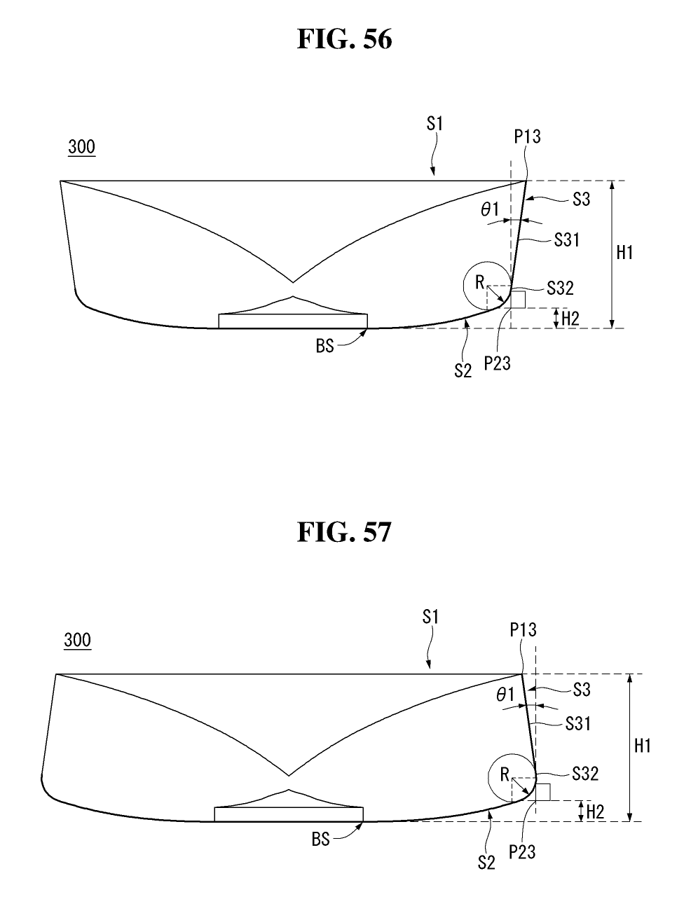

Referring to FIG. 56, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 57, the inclined surface of the second surface S2 may be curved. The fact that the inclined surface of the second surface S2 is curved may mean that the inclined surface of the second surface S2 entirely has a convex cross-sectional shape toward the outside of the lens 300. Thus, the inclined surface of the second surface S2 may entirely have a plate shape. A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. The predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

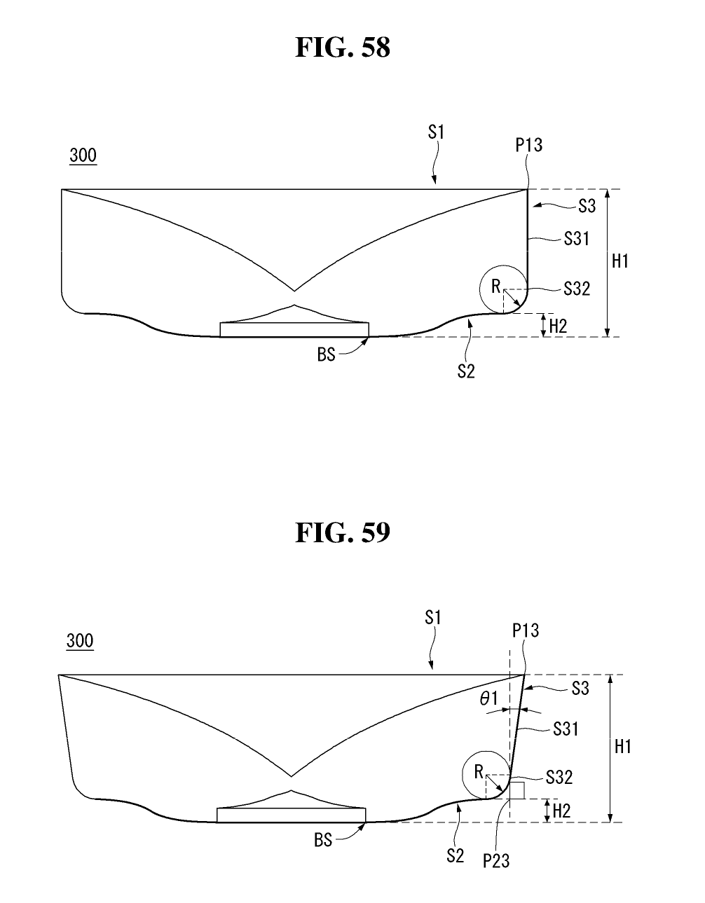

Referring to FIG. 58, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 59, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

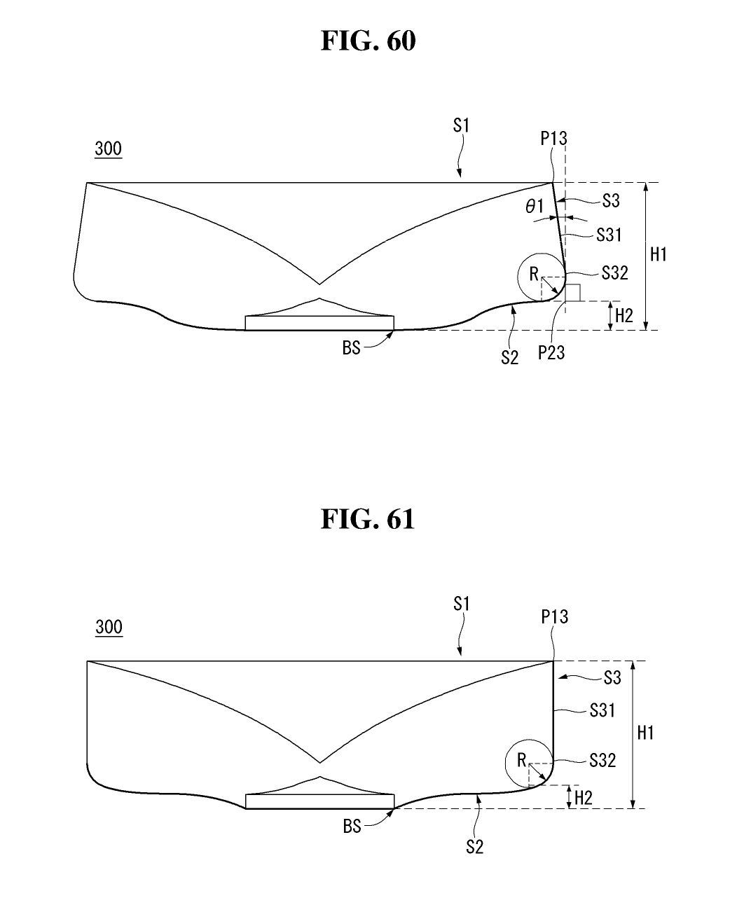

Referring to FIG. 60, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. The predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 61, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

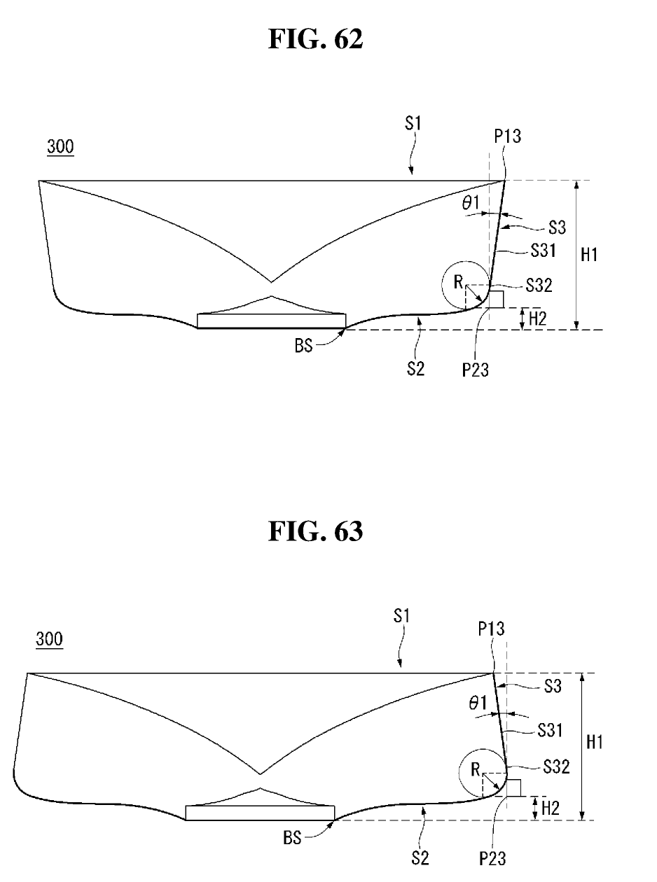

Referring to FIG. 62, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. In this instance, the predetermined angle θ1 may be inclined from the vertical dotted line in a clockwise direction CW. The predetermined angle θ1 may be between 0° and 5°. For example, the third surface S3 may be formed as the shape inclined from the vertical dotted line starting at the boundary point P23 between the second surface S2 and the third surface S3 by about 1° in the clockwise direction CW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

Referring to FIG. 63, the inclined surface of the second surface S2 may be curved several times. The fact that the inclined surface of the second surface S2 is curved several times may mean that the inclined surface of the second surface S2 has a cross-sectional shape, which is convex toward the outside of the lens 300 and is concave toward the inside of the lens 300. Namely, a cross section of the inclined surface of the second surface S2 may have an inflection point. In this instance, the inflection of the inclined surface of the second surface S2 may be configured such that the second surface S2 starts to be convexly formed from the bottom surface BS of the lens 300 toward the outside of the lens 300 and then is concavely formed toward the inside of the lens 300 as the second surface S2 is close to the third surface S3.

A height H2 at a position where the inclined surface of the second surface S2 and the third surface S3 meet each other may be equal to or less than ⅓ of a total height H1 of the lens 300. When the height H2 is equal to or less than ⅓ of the total height H1 of the lens 300, the control of light at the side of the lens 300 may be more efficiently performed.

The third surface S3 may have a shape entirely inclined from a vertical dotted line by a predetermined angle. The predetermined angle may be within the range of a predetermined angle θ1 from the vertical dotted line starting at a boundary point P23 between the second surface S2 and the third surface S3. The predetermined angle θ1 may be inclined from the vertical dotted line in a counterclockwise direction CCW. The predetermined angle θ1 may be between 0° and 5°. For example, the third surface S3 may be formed as the shape inclined from the vertical dotted line starting at the boundary point P23 between the second surface S2 and the third surface S3 by about 1° in the counterclockwise direction CCW.

The third surface S3 may include a straight surface S31 and a curved surface S32. The straight surface S31 may extend from a boundary point P13 toward the second surface S2. The curved surface S32 may be positioned between the straight surface S31 and the second surface S2. Namely, the curved surface S32 may be closer to the second surface S2 than the straight surface S31.

The curved surface S32 may be formed at a location corresponding to a shape of an imaginary circle or an imaginary oval of a predetermined range. A curvature R of the curved surface S32 may be diversified. The curvature R of the curved surface S32 may be different from a curvature of the second surface S2.

Because the curvatures of the curved surfaces of the lens 300 are different from one another, a path of light from the light source may be further diversified. Namely, light from the light source is not concentrated at a specific location or a specific area and may be uniformly radiated.

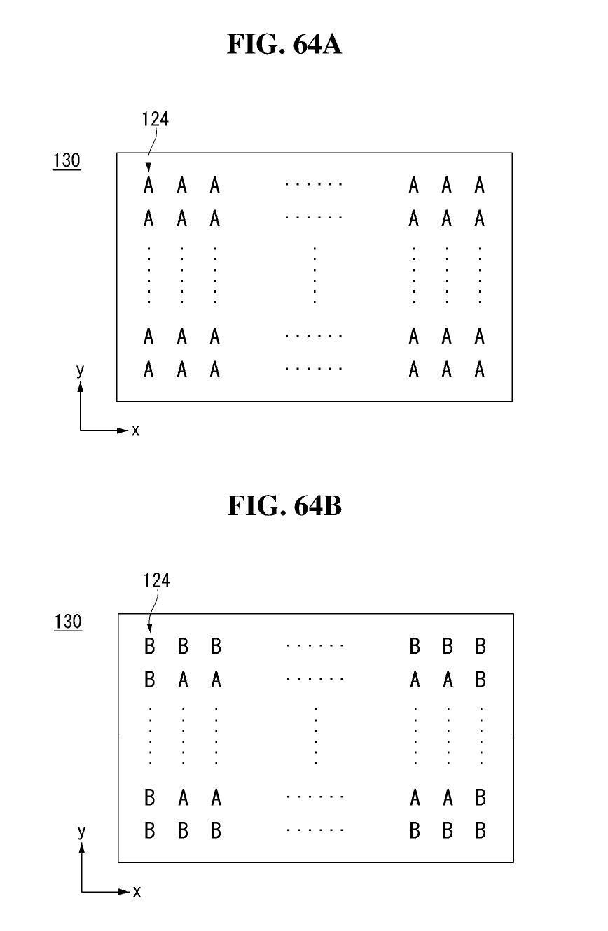

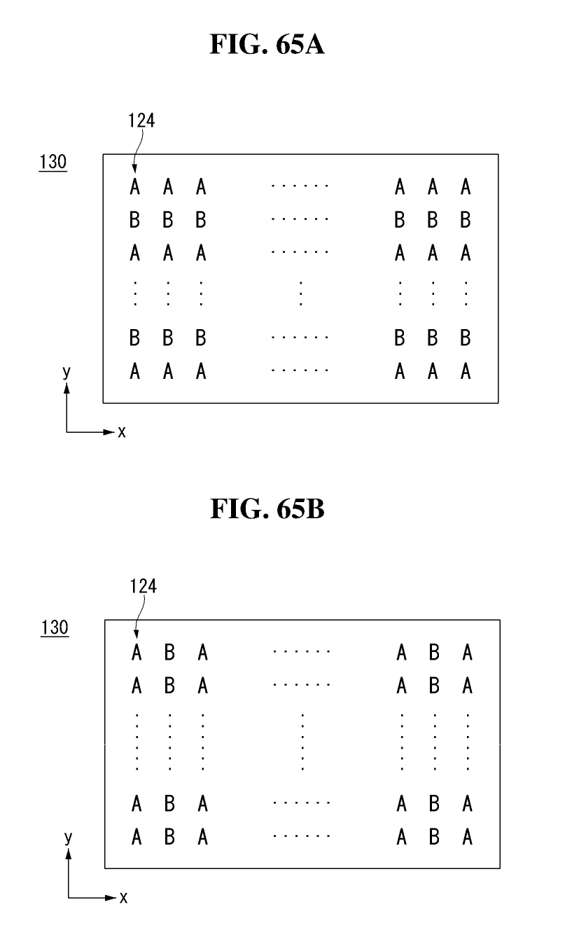

FIGS. 64 and 65 show a disposition of a light assembly according to another example embodiment of the invention.

As shown in FIGS. 64 and 65, the light assembly 124 may be positioned on the frame 130. The light assembly 124 may be configured in various shapes depending on a location. The light assembly 124 may include at least one of the lenses 300 having the above-described shapes. Thus, a contrast or a hot spot resulting from the lens 300 may be prevented from being generated.

As shown in FIG. 64A, the light assembly 124 may be positioned on the frame 130. In FIGS. 64 and 65, alphabets “A” and “B” indicate the light assembly 124. Namely, the light assemblies 124 may be arranged in the horizontal and vertical directions.

The light assemblies 124 shown in FIG. 64A may the “A” type light assemblies 124. For example, the light assembly 124 including the lens 300 of the specific shape may be positioned.

As shown in FIG. 64B, the “A” type light assemblies 124 and the “B” type light assemblies 124 may be arranged. For example, the light assemblies 124 including the lenses 300 of two types may be arranged. In this instance, the “B” type light assemblies 124 may be arranged on the outermost side of an array of the light assemblies 124, and the “A” type light assemblies 124 may be arranged in an inner area of the array.

The light assemblies 124 different from the light assemblies 124 arranged in the inner area of the array may be arranged on the outermost side of the array. Thus, the light assembly 124 positioned on the outermost side of the array may include the lens 300 different from the light assembly 124 positioned in the inner area of the array, so as to uniformly distribute light.

As shown in FIGS. 65A and 65B, the light assemblies 124 of at least two types may be alternately arranged. For example, the light assemblies 124 each including the “A” type lens 300 and the light assemblies 124 each including the “B” type lens 300 may be alternately arranged in the horizontal direction or the vertical direction.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An optical lens comprising:
a first surface at an upper part of the optical lens;
a second surface at a lower part of the optical lens, wherein a portion of the second surface is a bottom surface of the optical lens and parallel to a portion of the first surface; and
a third surface connecting the first surface and the second surface,
wherein an inclined portion of the second surface is at an angle from the bottom surface to the third surface.

2. The optical lens of claim 1, wherein the inclined portion of the second surface has a cross-sectional shape which is straight from the bottom surface to the third surface.

3. The optical lens of claim 1, wherein the inclined portion of the second surface has a cross-sectional shape which is curved from the bottom surface to the third surface.

4. The optical lens of claim 1, wherein the inclined portion of the second surface has a cross-sectional shape which is concave toward an inside of the optical lens.

5. The optical lens of claim 1, wherein the inclined portion of the second surface has a cross-sectional shape which is convex toward an outside of the optical lens.

6. The optical lens of claim 1, wherein the inclined portion of the second surface has a cross-sectional shape which is concave toward an inside of the optical lens and is convex toward an outside of the optical lens.

7. The optical lens of claim 1, wherein a height between the bottom surface and a point where the second surface and the third surface meet each other is equal to or less than ⅓ of a height between the bottom surface and a top of the upper part.

8. The optical lens of claim 1, wherein the third surface includes a straight portion starting at a point where the first surface and the third surface meet each other and a curved surface starting from an end of the straight portion to the second surface.

9. The optical lens of claim 1, wherein the third surface is not perpendicular to the bottom surface.

10. The optical lens of claim 9, wherein the third surface is at an angle equal to or less than 5° with respect to the bottom surface.

11. The optical lens of claim 1, wherein a central area of the second surface includes a concave portion extending toward the first surface.

12. The optical lens of claim 11, wherein the concave portion includes:
a first area obliquely extending from a center point of the concave portion toward an outside of the second surface;
a second area extending from the first area substantially parallel with the bottom surface; and
a third area extending from the second area to the bottom surface.

13. The optical lens of claim 12, wherein a portion of the third area includes a curved surface.

14. The optical lens of claim 1, wherein the first surface includes a concave portion extending toward the second surface.

15. The optical lens of claim 14, wherein the concave portion extends from a center point of the concave portion to a point where the first surface and the third surface meet each other.

16. The optical lens of claim 14, wherein the concave portion is angled from a point where the first surface and the third surface meet each other to a center point of the concave portion.

17. A backlight unit comprising:
an optical sheet;
a substrate opposite the optical sheet;
a light source between the substrate and the optical sheet and on the substrate; and
an optical lens covering the light source, the optical lens including:
a first surface at an upper part of the optical lens;
a second surface at a lower part of the optical lens, wherein a portion of the second surface is a bottom surface of the optical lens; and
a third surface connecting the first surface and the second surface,
wherein an inclined portion of the second surface is at an angle from the bottom surface to the third surface.

18. A display device comprising:
a display panel;
a backlight unit behind the display panel;
a frame behind the backlight unit; and
a back cover behind the frame,
wherein the backlight unit includes a light source and an optical lens covering the light source, the optical lens including a first surface at an upper part, a second surface at a lower part, a portion of the second surface forming a bottom surface, and a third surface connecting the first surface and the second surface,
wherein an inclined portion of the second surface is at an angle from the bottom surface to the third surface.

19. The display device of claim 18, wherein the backlight unit further includes:
an optical sheet;
a substrate opposite the optical sheet; and
a light source between the substrate and the optical sheet and on the substrate.

20. The display device of claim 18, wherein a diameter of the first surface of the optical lens is different than a diameter of the second surface of the optical lens.
